(19) United States
(12) Patent Application Publication
(10) Pub. No.: US 2005/0203759 A1
(43) Pub. Date: Sep. 15, 2005

(54) Method of exploring (wheel)

(76) Inventor: Joel A. Barker, St. Paul, MN (US)

Correspondence Address: Angenehm Law Firm, Ltd., P.O. Box 48755, Coon Rapids, MN, 55448-0755, US

(21) Appl. No.: 10/800,143

(22) Filed: Mar. 12, 2004

(51) Int. Cl. G06F 17/60

(52) U.S. Cl. 705/1

(57) ABSTRACT

A method of exploring including the steps of writing center text; displaying the center text in a center node; writing first order implications, each first order implication forming at least a part of an arc; displaying each first order implication in a first order node; connecting each first order node to the center node; writing any desired child implications of any existing implications; displaying the child implications in child nodes; and connecting the child nodes to an associated parent node to form a wheel.

### FIELD OF THE INVENTION

The present invention relates to tools for exploring possibilities and more particularly to tools used for exploring and evaluating the likelihood and significance of possible events.

### BACKGROUND OF THE INVENTION

People have long predicted the future. For instance, if a spouse presents flowers to their partner, they can predict that the reaction will be favorable. It is possible that the partner could not react or react negatively. Other implications are also possible. People are comfortable with predicting based upon the occurrence of an event. If “X” occurs then “Y” may be the result. From this very simplified methodology there is a very substantial room for improvement.

A tool has been developed and sold under the trademark IMPLICATIONS WHEEL® developed and sold by the current inventor, Joel A. Barker. This tool essentially follows the format of If “X” occurs then “Y” may result. The tool, identifies many of the different implications that may flow from “X.” Then additional layers may be followed out, separately treating each “Y” portion of the equation as a new “X” and looking for the next round of implications. The process may be repeated as many times as desired to reach out as far into the future as desired.

This tool has been important within corporate America due to the commercial advantage of being extremely well positioned for the future. For instance, a company may wish to understand what could result from buying out another company. Some of the immediate implications may include anti-trust problems, strategic partner benefits, combining of research and development departments and other potentially readily discemable implications. Less discernable implications are more readily uncovered with the aid of the IMPLICATIONS WHEEL® brand exploring tool. Subsequent layers of implications may also be uncovered or revealed by the tool. For instance, innovative new product may result from cross-fertilization of ideas in a combined research and development department.

The IMPLICATIONS WHEEL® brand method of predicting the future has some drawbacks until now. Previously, the tool used paper to record all the implications. The pieces of paper could become very large, covering more than an entire wall of a room. The tool could take days to review and understand and selected implications could not be presented in a prominent fashion particularly based upon a subject. Scoring from multiple viewpoints was not recorded ion a single chart, which precluded comparison of conflicting scoring. As nodes change from a non-scored status to a scored status or changed from one score to another was any prior designation of its status removed, thus creating a mess as changes were made.

Previous versions of the Implications Wheel® were confusing to score during the Wheel generation process. Highly desirable implications were circled in blue. Highly undesirable implications were circled in red. If any highly desirable or highly undesirable implication was also likely it was given an additional circle in the same color as the initial circle that represented desirability or undesirability. This system of circles around implications meaning desirability in one case, and likelihood in another was very confusing to I-Wheel participants, especially with groups who were new to the process. In the prior art, desirability or likelihood indicators were not placed inside nodes, perhaps because doing so interfered with the legibility of the text written in the implication node. The scoring legend being confusing, increased the chances of unintended scores, which introduces faulty data into the process. The faulty data was then potentially used in making final decisions.

What is needed is an improved tool for predicting events, normally in the future, but potentially in the past. The tool should provide summaries of significant implications, allow for scoring according to multiple view points without disclosing the scoring according to other viewpoints, scored (importance, likelihood and perhaps time) implications and non-scored implications should each have a specific designation that is removable as the implication moves between non-scored and scored and replaced with the proper designation. Preferably, the scoring legend is clearer for use during the initial scoring process. For example, a circle about a node should only indicate likelihood, not desirability the first time it is circled and likelihood the next time. Desirably, all regions with respect to the node, e.g., inside, outside and the lines or circle defining the node, should all be useable as areas for placing scoring indicators. Other features for the ease of use, comprehension and security, e.g. encryption, should also be included to enhance the usability and understandability of the tool.

### SUMMARY OF THE INVENTION

The present invention is a method of exploring including the steps of: writing center text; displaying the center text in a center node; writing first order implications, each first order implication being the starting point for a cascading arc of implications; displaying each first order implication in a first order node; connecting each first order node to the center node; writing any desired next order (child) implications of any existing implications; displaying the child implications in child nodes; and connecting the child nodes to an associated but immediate previous (parent) node to form a wheel; preparing and displaying a summary of the wheel including only those implications, together with any ancestor implications necessary to connect to the center text, that are both significant implications and that match any user determined auxiliary summary parameters.

Optionally, the method may provide the step(s) of:
preparing and displaying a summary of the wheel including only those implications, together with any ancestor implications necessary to connect to the center text, that are both significant implications and match any user determined auxiliary summary parameters;
visually rotating the wheel in a plane skewed to a plane defined by a monitor screen;
rotating the wheel when any node is selected; the selected node is enlarged as it is rotated to the foreground;
displaying the nodes forming the wheel in a diminished mode such that the implication within the node is not revealed;
fully displaying each node including revealing each implication within each node;
fully displaying a portion of the nodes, including revealing the implications within some of the nodes;
encrypting data associated with one arc and electronically distributing that arc for completion and scoring;
preparing and displaying a conflict summary wheel including only those implications, together with any ancestor implications necessary to connect to the center text, that both are significant implications and received a conflicting score between at least two different viewpoints;
visually removing indicia designating a node as non-scored and marking the node as scored once the node is scored; and/or
visually rotating the conflict summary wheel in a plane skewed to a plane defined by a monitor screen.
   These and other options will be understood from the description, drawings and appendix.

This method provides several advantages including the ability to prepare a summary wheel with the significant nodes on a particular user determined subject.

Another advantage is that the wheel may be positioned and rotate on a monitor to present a selected node in the foreground.

Still yet another advantage is that the nodes may be enlarged or diminished to reveal or conceal the associate implication.

As yet another advantage some of the nodes may be enlarged or diminished to reveal or conceal the encapsulated implication.

A further advantage is that the data associated with an arc may be encrypted and distributed for completion and scoring.

Still further, conflict scoring summary wheels may be displayed with significant nodes that receive conflicting scores according to two or more viewpoints.

Another advantage is that the summary wheel or conflict summary wheel may be visually rotated on a monitor to position a selected node in the foreground.

As still yet another advantage, non-scored nodes, may have indicia marking the nodes as non-scored removed and replace with markings showing the node as scored, once the scoring is complete.

These and other advantages are further explained in the description, shown in the drawings and illustrate in the appendix.

### DESCRIPTION OF THE DRAWINGS

FIG. 1 is a flowchart showing a preferred logic for launch and registration;

FIG. 2 is a flowchart showing a preferred logic for adding first order implications;

FIG. 3 is a flowchart showing a preferred logic for the interface;

FIG. 4 is a flowchart showing a preferred logic for adding any order implications;

FIG. 5 is a flowchart showing a preferred logic for distributing arcs for completion;

FIG. 6 is a flowchart showing a preferred logic for distributing arcs for scoring;

FIG. 7 is a flowchart showing a preferred logic for assembling arc data returned by arc program;

FIG. 8 is a flowchart showing a preferred logic for scoring in wheel;

FIG. 9 is a flowchart showing a preferred logic for timing in wheel;

FIG. 10 is a flowchart showing a preferred logic for preparing a summary wheel;

FIG. 11 is a flowchart showing a preferred logic for conflict summary wheel;

FIG. 12 is a flowchart showing a preferred logic for exiting the program;

FIG. 13 is a screen shot allowing the user to verify the subscription on the server side;

FIG. 14 is a screen shot that may appear to acquire subscription log-in data;

FIG. 15 is a screen shot allowing the user to open an existing file, create a new file or quit;

FIG. 16 is a screen shot allowing a user to open an existing file;

FIG. 17 is a screen shot allowing a user to create a new file;

FIG. 18 is a screen shot allowing identification of the authors of a wheel;

FIG. 19 is a screen shot allowing entry of background information about a wheel;

FIG. 20 is a screen shot providing for entry of the center text;

FIG. 21 is a screen shot showing entry of center text;

FIG. 22 is a screen shot showing entry of a first or any order implication together with the center;

FIG. 23 is a screen shot showing entry of a first order implication together with the center and a previously entered first order implication;

FIG. 24 is a screen shot showing entry of a first order implication together with the center and numerous previously entered first order implications;

FIG. 25 is a screen shot showing entry of a first order implication together with a page of previously entered first order implications being move to a hidden page;

FIG. 26 is a screen shot showing entry of a first order implication on a new page with the center;

FIG. 27 is a screen shot reminding the user to enter at least one positive and one negative implication;

FIG. 28 is a screen shot showing the “file” menu of the interface;

FIG. 29 is a screen shot showing the “tools” menu of the interface;

FIG. 30 is a screen shot showing the “implications” menu of the interface;

FIG. 31 is a screen shot showing the “view” menu of the interface;

FIG. 32 is a screen shot whereby an entity may select a client and the client may distribute arcs for completion and optionally scoring;

FIG. 33 is a screen shot whereby a user may distribute arcs for completion and optionally scoring;

FIG. 34 is the screen shot of FIG. 33 wherein an arc group has been selected;

FIG. 35 is a screen shot showing the wheel and a first order implication has been selected to illustrate the center, lines and a first order node

FIG. 36 is a screen shot similar to FIG. 35 and further illustrating the wheel displayed in a scoring mode;

FIG. 37 is a screen shot showing the detailed scoring interface;

FIG. 38 is a screen shot showing the fast scoring interface;

FIG. 39 is a screen shot showing the wheel in scoring mode with some nodes scored as significant nodes;

FIG. 40 is a screen shot showing a summary report of the wheel;

FIG. 41 is a screen shot showing the timing interface;

FIG. 42 is a screen shot showing a scored and timed wheel; and

FIG. 43 is a screen shot showing a conflicts report.

### DETAILED DESCRIPTION OF THE PREFERRED EMBODIMENT

Definitions

An applicant is entitled to be his own lexicographer. Accordingly, applicant chooses the following definitions to apply to the description, claims and abstract, except as may otherwise be augmented in the detailed description:

Ancestor—An ancestor of an implication of a first or subsequent order implication or node is the center or any implication/node between the center and the reference implication/node.

Arc—An arc is a portion of a wheel, the data from which can be combined with other arcs and existing data into a wheel. An arc is made up of one first order implication followed by up to preferably 10 second order implications followed by up to preferably ten third order implications off of each second order implications. In a sense, it is a fractal of the complete wheel, but its presented shape may be a wedge instead of a wheel.

Center—The main or principle issue being explored with a wheel. Possible category centers include: an innovation, an emerging trend, a new policy, a new product brought out by a competitor; or a significant event, i.e. 9/11.

Center node (or hub)—The node in a wheel that represents the center or hub of the wheel and the starting point of the discussion.

Child (Children)—Any implication that has the reference implication as its parent is a child of the reference implication. Any implication that has the center as its parent is a child of the center.

Diminished node—a condensed node, opposite of enlarged node. A diminished node generally does node display an implication therein, but can show scoring.

Descendent—Any implication that has the reference implication as its ancestor is a descendent of the reference implication. Any first or subsequent order implication is a descendent of the center.

First (and subsequent) order implication—A direct possible implication of the center with no important intervening event. A second order implication is an immediate possible implication resulting from the occurrence of a first order implication. Subsequent levels of implications, third order, fourth order, etc., are direct possible implications resulting from the occurrence of the immediate preceding order of implication. I.e. parent implication.

First (and subsequent) order node—the graphic form that holds the text of a first order implication. Second order, third order, fourth order, etc. nodes correspond to similarly numbered implications.

Implication—a possible result or consequence that is triggered by a previous event.

Implications Wheel®—A brand of a team tool that help users discover possible future events in an orderly yet divergent pattern. An Implications Wheel® brand wheel is built using a disciplined methodology and a non-linear thinking process. Preferably, a wheel is displayed as a grouping of all desired orders of all identified possible implications flowing out of a single event.

Lead (or spoke)—a portion of a line extending partially between two nodes. A lead is displayed when one of the two nodes is not displayed. A lead is shown in FIG. * * * , e.g. four lines to a fourth order node with part of the line and the fourth order node not showing.

Lines—a connector between two nodes. A line may be paired with one or more lines as described below.

Magnified Node—an enlarged node, opposite of diminished node.

Minority opinion—a scoring opinion or a portion of a group that constitutes less than a majority.

Minority report—the scoring result as prepared by those holding a minority opinion.

N (Nth)—a mathematical variable.

Node—An area in which text data concerning an implication may be recorded or displayed. Preferably, a node is displayed in the shape of a circle or oval, with certain very special nodes displayed in the shape of a star or other non-circular shape. A node may be displayed as diminished, normal or enlarged.

Order—The number of ancestors of the reference implication.

Parent—The parent of some implication is the immediate ancestor of the reference implication. That is, the ancestor that is connected to the reference implication without intervening implications.

Point of View—The perspective used for scoring of a node, arc, or wheel done by one entity, person or group. Any wheel can be scored from multiple points of view, e.g., legal, engineering, marketing, staff, natural and/or other.

Reference implication—The implication being discussed or chosen. Syn. Selected implication.

Sibling implications—children of the same parent implication.

Significant node—a node that is scored a +4 or greater score or −4 or lesser score.

Strand—The chain of implications 11 being ancestors of the same implication, including that reference implication and reaching all the way back to include the center.

Time Diamond—an area in which judgements concerning the amount of time between implications is indicated.

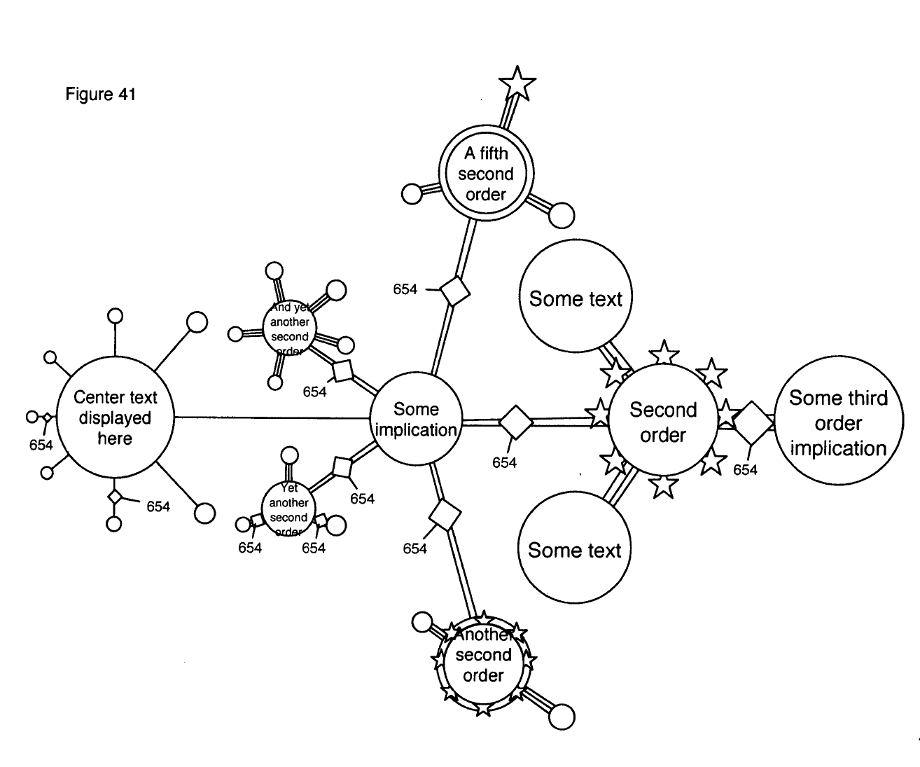

Wheel—a graphical representation of all identified implications that may directly or indirectly flow from a given center. Implications Wheel® is the preferred brand of a wheel. An example of a wheel is shown in FIG. 41.

Launch and Registration

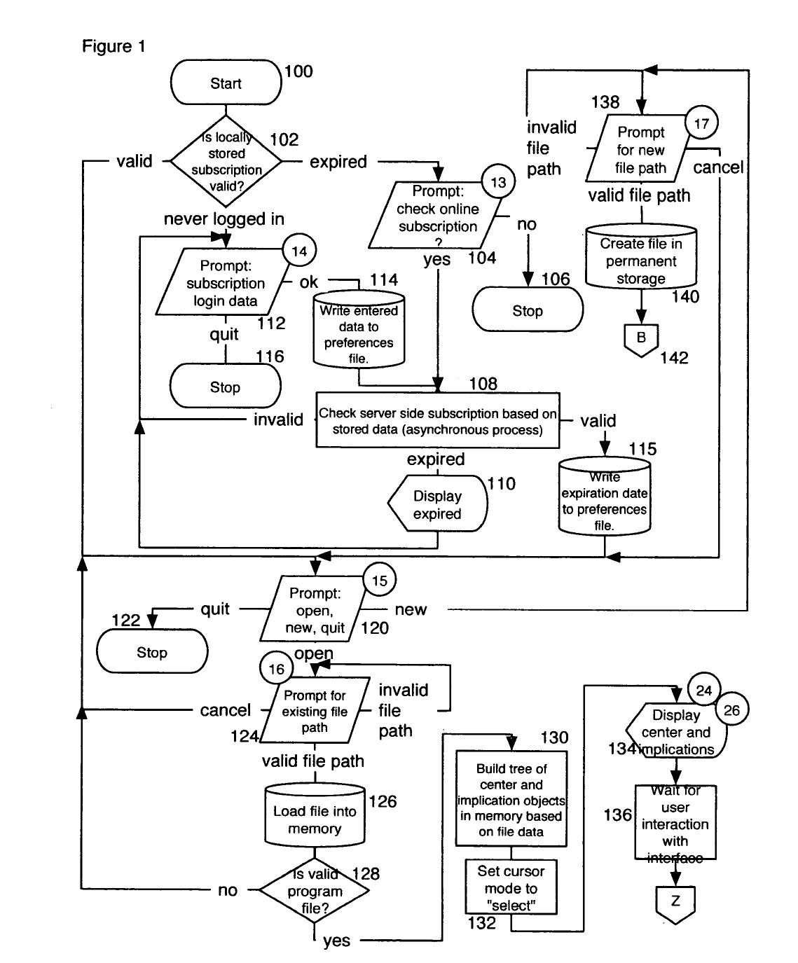

FIGS. 1-12 are flowcharts demonstrating a preferred methodology for making and using the present invention. Referring to FIG. 1, ovals, such as oval 100, demonstrate a terminal point in the method. Oval 100 indicates the starting point for the future exploration method, which may be initiated in any manner known in the art, including those manners known in the art of computer software.

Diamonds, such as diamond 102, indicate a methodology decision making point. Diamond 102 determines whether the subscription for the use of the methodology is current. Remuneration models other than subscription may be used, however, the present inventor opines that subscriptions are the best manner of offering the present invention for use. Another preferred mode is charging per arc as each arch passes through a registry. The determination at diamond 102 checks the user's computer to see if the subscription is current and valid. Three possible outcomes to this decision are “valid,” “expired,” and “never logged in.” “Never logged in” occurs the first time an instance of the program is executed on a given computer and thereafter until a valid subscription is confirmed with the server.

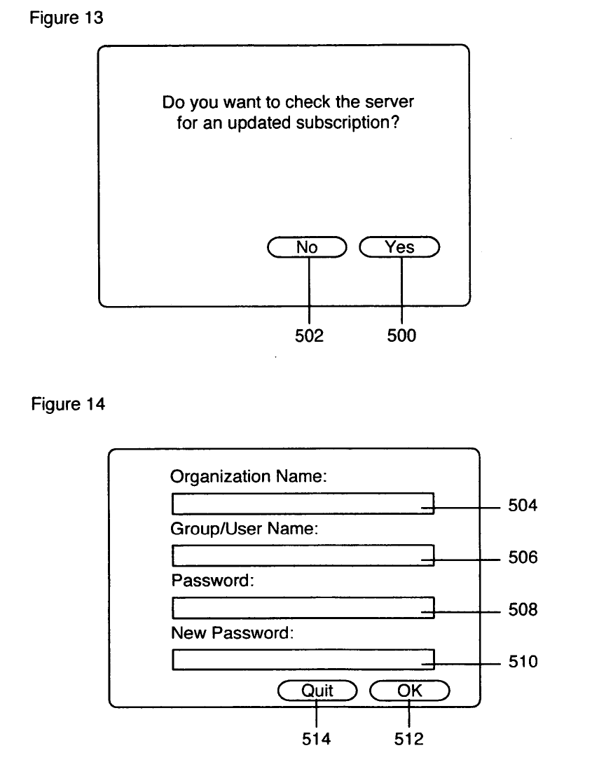

Expired—If the subscription has expired, the next step indicated by parallelogram 104 is to provide a user-determined decision. Parallelograms, such as parallelogram 104, indicate points of user interaction. The encircled number touching on parallelogram 104 encases indicia with such indicia referring to a figure number of the drawings. (Similar circles throughout this application having different indicia refer to different figures with a corresponding number to that shown in the circle.) The prompt shown at FIG. 13, asks whether the user wishes to verify the subscription on the server side. The subscription may be current on the server side and the user's computer has old information concerning validity. The user is given two options, “Yes” and “No,” which may be presented as buttons 500 and 502 respectively as indicated in FIG. 13. If “no” is selected the method terminates for lack of a current subscription as indicated in oval 106. If “yes” is selected, the method moves to a step indicated by rectangle 108.

Rectangles, such as rectangle 108, indicate a process performed, perhaps via a computer. At rectangle 108, the server side computer is checked to see if the subscription is “valid,” “expired,” or “invalid.” A “valid” response is treated the same as a “valid” response from diamond 102, which will be discussed shortly. An “expired” response is treated similarly to an “invalid” response from rectangle 108, except that a message identifying the subscription as “expired” may appear if the subscription is “expired.” Displaying such message is indicated in oval-arrow 110.

“Expired” and “invalid” responses from oval-arrow 110 and a “never logged in response from diamond 102 have a prompt as part of the next step. Parallelogram 112 indicates a prompt seeking subscription login data from the user. An example of such a prompt is shown in FIG. 14. The user may click the button 514 of FIG. 14, reading “quit”, which invokes the step of terminating the program as indicated in oval 116 of FIG. 1. Alternatively, the user has the option of entering data into the fields 504, 506, 508 and 510 perhaps with titles as indicated in FIG. 14 and clicking button 512, which invokes the step for writing entered data to a preferences file as indicated in cylinder 114 of FIG. 1. A cylinder, such as cylinder 114, indicates data being recorded to or read from a data file. From the step of recording data, cylinder 114, the method rechecks the server side subscription based upon store data as previously described with regard to rectangle 108.

Opening Files

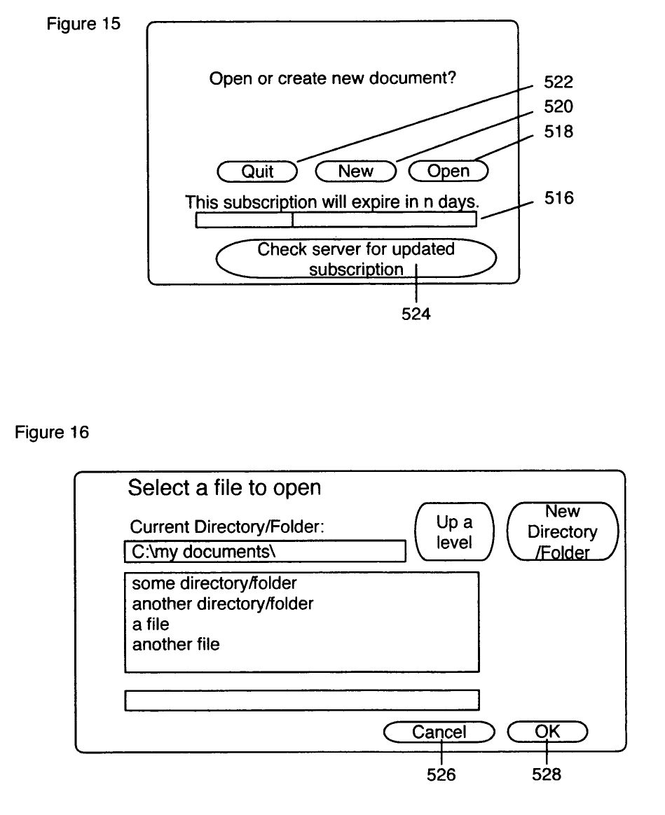

A “valid” response from either diamond 102 or rectangle 108, e.g. a valid non-expired subscription shown either on the user's computer or the server side computer, allows the user to open a file. A “valid” response from rectangle 108, causes the subscription expiration date to be written to the preferences file, cylinder 115. A prompt, as shown in FIG. 15 and indicated at parallelogram 120, will be displayed. The user may be informed of the amount of time remaining on the subscription with an indicator 516 and asked whether to “open” an existing file, create a “new” file, or “quit” with buttons 518, 520, and 522 respectively. Each of these three options will be explored in a moment.

At this point, the user may also be given the opportunity to verify the remaining time on the subscription as recorded on the server side. Please note that the user's computer data would not be accurate if the subscription was renewed on the server side and not synchronized on the local computer. The program flow could have reached parallelogram 120 via diamond 102 and the server side would not have been checked in the process at rectangle 108. Selecting button 524 indicating a desire to check the server side provides a next step, at rectangle 108, of checking the subscription at the server side computer. Whereupon, the following step is as previously described when rectangle 108 was first introduced. Selecting “quit”, perhaps with button 522 of FIG. 15, provides a next step of terminating the method as indicated at oval 122 in FIG. 1.

Open Existing File

Selecting “open” causes a prompt to be displayed perhaps as shown in FIG. 16 and indicated at parallelogram 124 (FIG. 1) to be presented, seeking user input identifying the file path. FIG. 16 generally is a file directory such as that commonly known in the art of computer programming and includes buttons for cancel 526 and acceptance 528 of the identified file. The three possible results are: “cancel”, which re-initiates the step described at parallelogram 120, “invalid file path”, which re-initiates the prompt for existing file path at parallelogram 124, and “valid file path”, which loads the file into memory as indicated in cylinder 126.

Once the file is loaded, the file is verified to determine if it is a valid file for this particular method. Such step is indicated at diamond 128. A “no” or “invalid” response may mean that the user is trying to access a file that cannot be interpreted as meaningful data for the methodology. Accordingly, a “no” response leads to the step described with regard to parallelogram 120 and FIG. 15. A “yes” or “valid” response at diamond 128 initiates a couple processing steps, shown in rectangles 130 and 132.

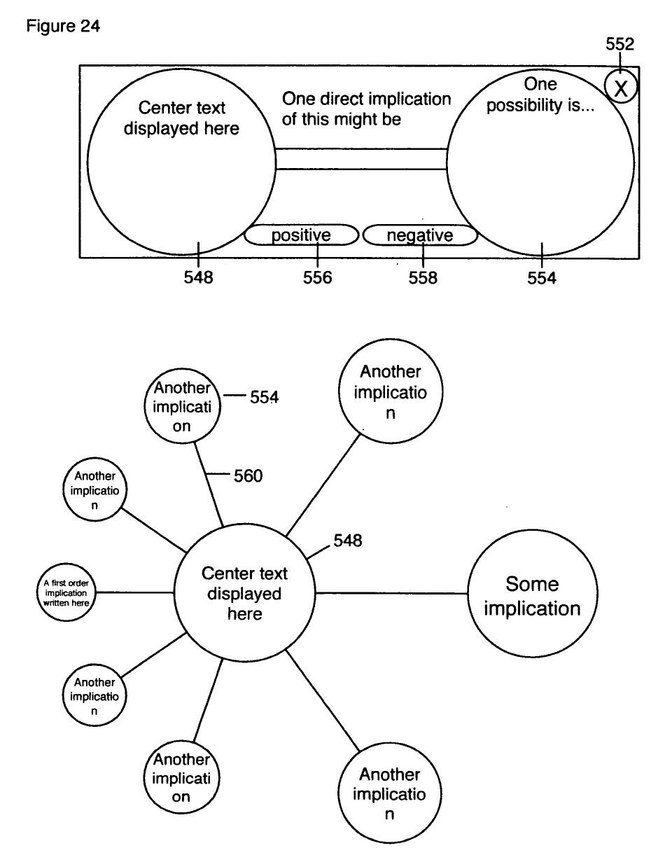

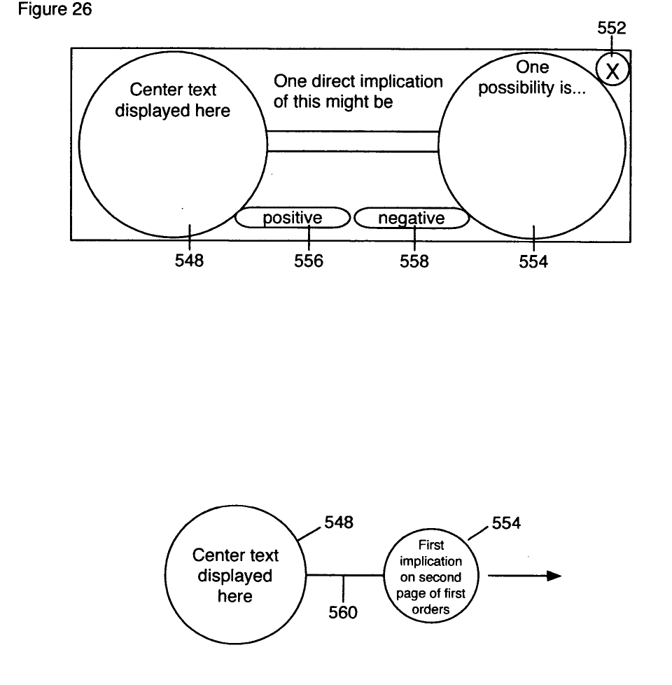

Specifically, the data in the file is organized into a tree structure with the center as its root and descendent implications as nodes as described throughout this writing. Any other data or database structure that allows for representation of the data for this methodology may be substituted for the tree structure. Further, the cursor, is set to “select” mode, which allows a user to select any node of the choice. The center node and descendant nodes are displayed as indicated in oval-arrow 134 and shown in FIGS. 24 and 26. The oval-arrow shape as used throughout the flow-charts indicates an on-screen display. The wheel structure visually rotates on the monitor in a plane skewed to the screen when the cursor is in the select mode such that a node being selected is moved to the foreground.

The following method is used of maximize the size of implication being examined, while minimizing the space consumed by other nodes and yet allows that positioning of the implication being examined to be shown in respect to the wheel as a whole. All implications may be shown radially around their respect parent nodes. The shape may be spherical, circular or other shape. If a circular shape is employed, then the circle may be displayed so as to appear tilted into the plane of the screen. In this case, the circles, containing implications and disposed about their parent node, appear oblong and distorted when considered two-dimensionally. Additionally, implications and nodes displayed as further away appear smaller than implications and nodes that are closer to the foreground, e.g., selected nodes. For example, in FIG. 44, a first order implication is selected and in FIG. 45, a second order implication is selected.

Selecting an implication moves the implication to the foreground and moves the remaining implications to the middle or background. This may involve a visual rotation of the wheel. If the selected node is the center 548, the center 548 may move to the foreground from the middle ground. The further a particular node is from a selected node, when considered in the form of a wheel, the smaller the node is presented.

The selected implication and all of its ancestors may be displayed with their implication text visible in the node associated with each implication. The center node 548 may always be displayed with the text of the center. The children of the selected implication are displayed with their respective implication text. All other nodes are displayed as a diminished node, e.g. not displaying the text. All nodes whether diminished or not may be shaped and colored to reflect their score under the current point of view. See FIGS. 44 and 45.

The next step, a process step as indicated by rectangle 136 involves waiting for user interaction with the interface, which is described below.

Open New File

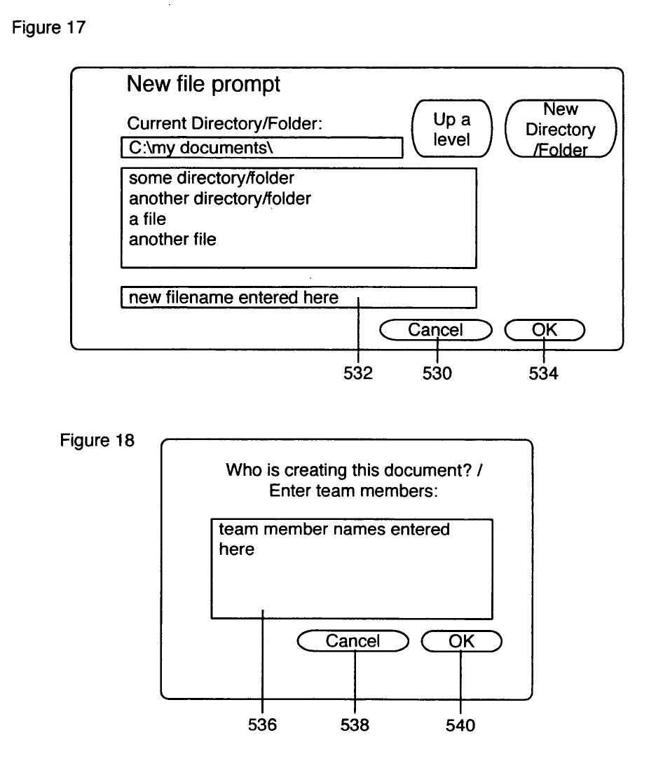

While at the step indicate by parallelogram 120, the user may select to open a “new” file. Upon such selection, a prompt, such as that shown in FIG. 17 and indicated at parallelogram 138 may appear. The user may cancel, pressing button 530, and be referred to the step previously described with regard to parallelogram 120 or enter a file path perhaps in field 532 and accepting the path, pressing button 534. The path may be an invalid file path, which returns the user to the same prompt (FIG. 17), or a valid file path. A valid file path causes the method to create a file in permanent storage, as indicate in cylinder 140.

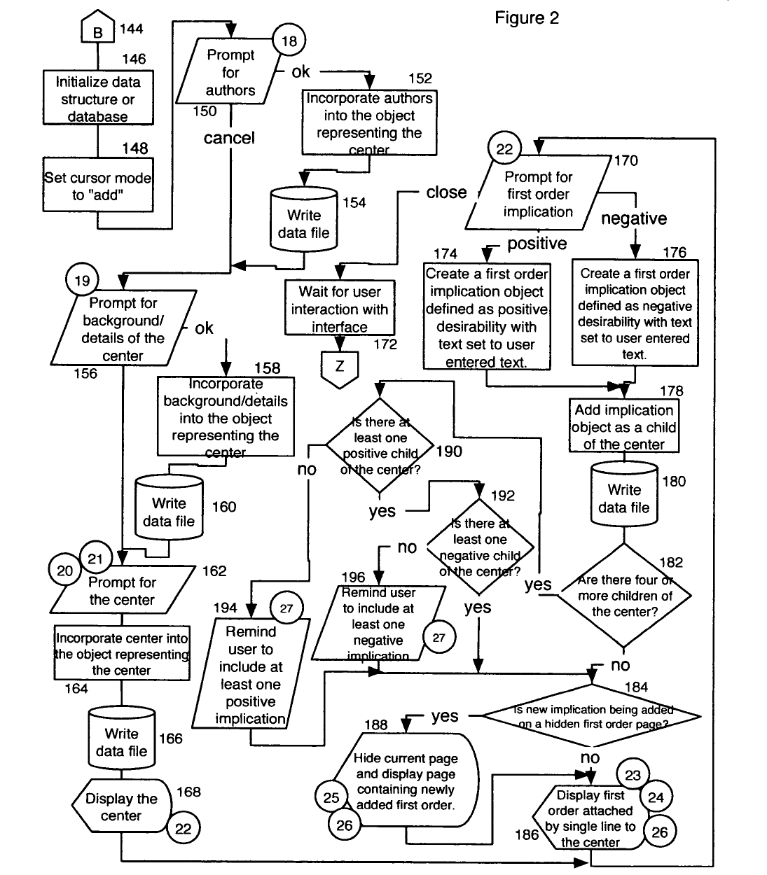

The flowchart of FIG. 1 moves from cylinder 140 to a pentagon 142. The pentagon is not a portion of the method, but rather is a connector used for purposes of describing the invention herein. The inverted pentagon 142, incases the indicia “B”, which corresponds to the upright pentagon 144 on FIG. 2, also containing the indicia “B”. in this sense, the pentagons are use to direct the reader to another figure and to identify the starting point on that new figure with the indicia coordinating the various pentagons shown throughout the drawings.

Add Data to New File

Now that a new file is opened, the user may add data supporting the file including first order implications. The next step, according to the invention and following the step discussed with regard to cylinder 140 on FIG. 1, is the a process step indicated on FIG. 2 by rectangle 146. There the data structure or database is initialized. The cursor mode may be set to “add”, see rectangle 148, which allows the user to input or write data. The cursor mode may be automatically set when creating a new file.

Initially, certain background information may be captured for later reference for subsequent users of the data file, including identification of the authors, background information/details of the center, and identification of the center as will now be described. A prompt 150 may appear, such as that shown in FIG. 18 and indicated by parallelogram 150 on FIG. 2, allows entry of the names of the authors, e.g. the person or persons generating the center and implications text, perhaps in field 536. The user may enter data and select either option “cancel” or “o.k.” perhaps with buttons 538 and 540 respectively. Selecting “o.k.” initiates the process step (rectangle) 152 of incorporating the authors in the object representing the center and writing the data to the file, cylinder 154.

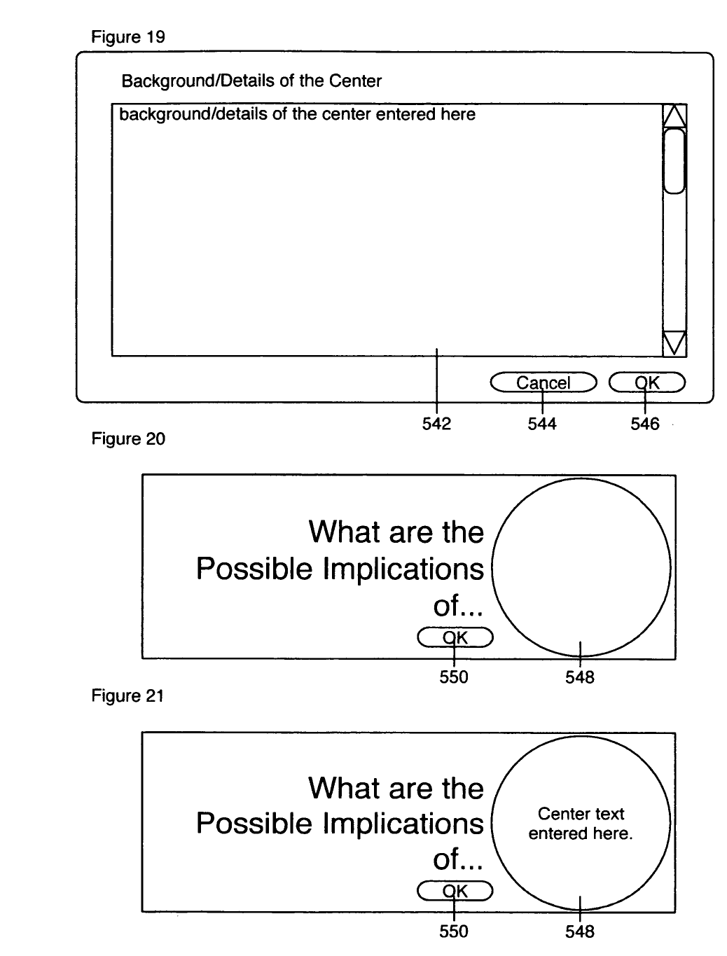

At this point, also reachable through selection of “cancel” at parallelogram 150, a prompt for background and details about the center may be presented, such as the prompt indicated at parallelogram 156 and shown in FIG. 19. Information may be recorded at this prompt perhaps in field 542 such as specific numbers and details that will not fit into a succinct center text or that would be distracting from the primary issue but are necessary for a complete understanding of what is meant by the center text, including, but not limited to, identification of the purposes and reasons why the authors wish to gather input on the center, time lines or other instructions arid information that they wish to share with subsequent users of the particular file. The user then has the option of selecting “cancel” or “o.k.”, perhaps using buttons 544 and 546 respectively. Selection of “o.k.” initiates the process step, rectangle 158, of incorporating the background and details into the object representing the center and writing the data to a file as indicated by cylinder 160 of FIG. 2.

At this point, also reachable by selection of “cancel” at parallelogram 156, a prompt may be presented seeking information for the center, parallelogram 162, such as that shown in FIGS. 20 and 21. FIG. 20 demonstrates a prompt as it might occur to the user and FIG. 21 demonstrates that the text describing the center may be recorded by the user in center 548. The center 548, once accepted perhaps through clicking button 550, may be incorporated in a process step, rectangle 164, into the object representing the center and the data may be written to the file, cylinder 166.

Add First Order Implications

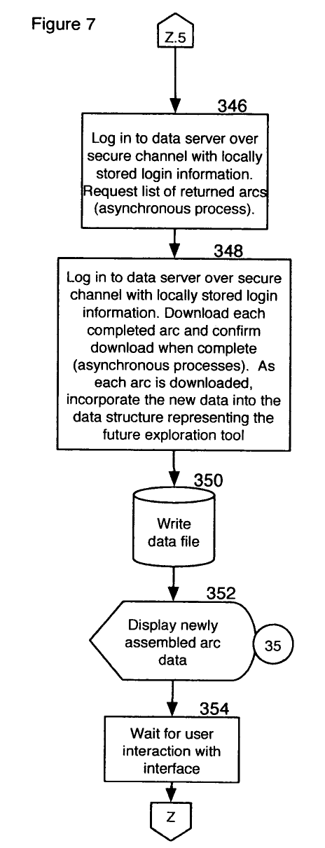

First order implications may be added as described in the following section or as described under the heading “Add Any Order Implication as described below. The center 548 may be displayed, oval-arrow 168, together with a prompt seeking first order implications, parallelogram 170 as shown in FIG. 7. The user may make one of three choices, namely close the window perhaps with button 552, add a positive first order implication or add a negative first order implication.

Should the button 552 be selected, the method has a process step of waiting for user interaction with the interface as described below, rectangle 172. Adding either a positive or a negative first order implication involves writing the text in a first order implication node 554 and identifying the implication as “positive” or “negative” perhaps with buttons 556 and 558 respectively. It should be stated that the occurrence of an event can have either positive or negative impact and on occasion both. The user determines whether it is positive or negative and declares it to be such. Should an implication be both positive and negative, then the implication should be rewritten as two separate implications each written so as to convey the specific positive or negative implication the user has in mind.

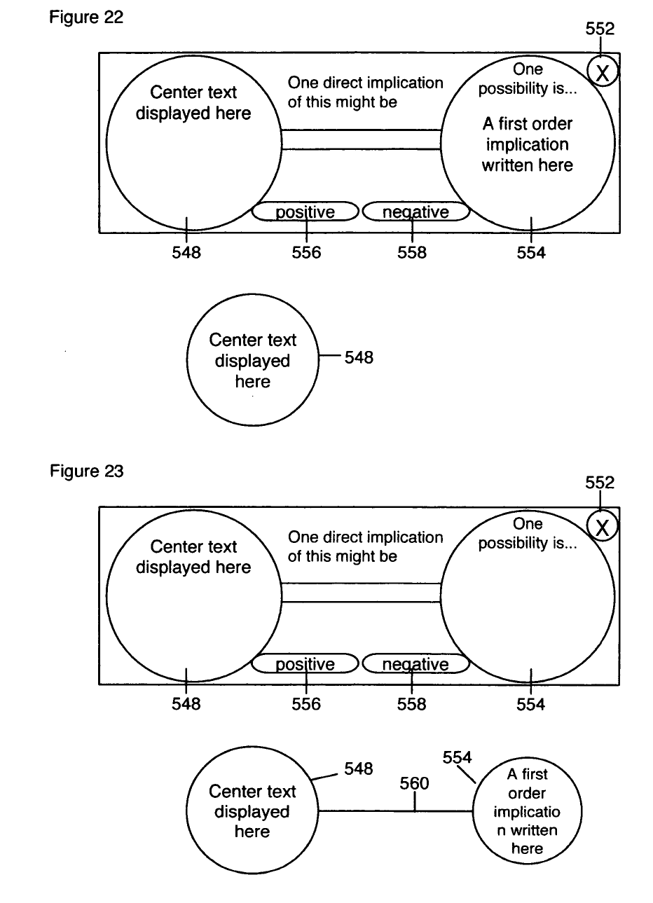

The method may then include the step of defining a first order implication object, defined either as positive or negative as the case may be, with the text set to that which the user input into first order node 554 in FIG. 22. See rectangles 174 and 176. The object is added, as a child, to the center object, rectangle 178, and written to the data file as indicated in cylinder 180.

A decision, diamond 182, is made as to whether there are four or more children of the center node 548, the outcome of which causes the method to initiate one of two loops. Assuming less than four first order implication nodes 554 have been written, a decision is made, diamond 184, as to whether the most recently written implication is being added on a hidden first order page.

Eventually if enough first order implication nodes 554 are added to the center node 548 display of the center node 548 with all first order implication nodes 548 become impractical. The designer of the software, or perhaps the user, may determine a maximum number of first order implication nodes 554 that may be displayed on a single page. Additional implications may appear on a hidden page such that no more than the selected number of first order implication nodes 554 will appear on a given page. Instead multiple pages are used.

If the newly created first order implication is not being written on a hidden page, the first order implication node 554 is displayed as being joined by a single line 560 to the center node 548 as shown in FIGS. 23, 24, and 26 and indicated in oval-arrow 186 of FIG. 2. FIG. 23 shows display of the first of the first order implication nodes 554 joined to the center node 548. FIG. 24 shows a number of first order implication nodes 554 joined to the center node 548. FIG. 26 demonstrates that multiple pages may be present, but as noted herein, newly added first order implication nodes 554 may be added to the page currently being displayed.

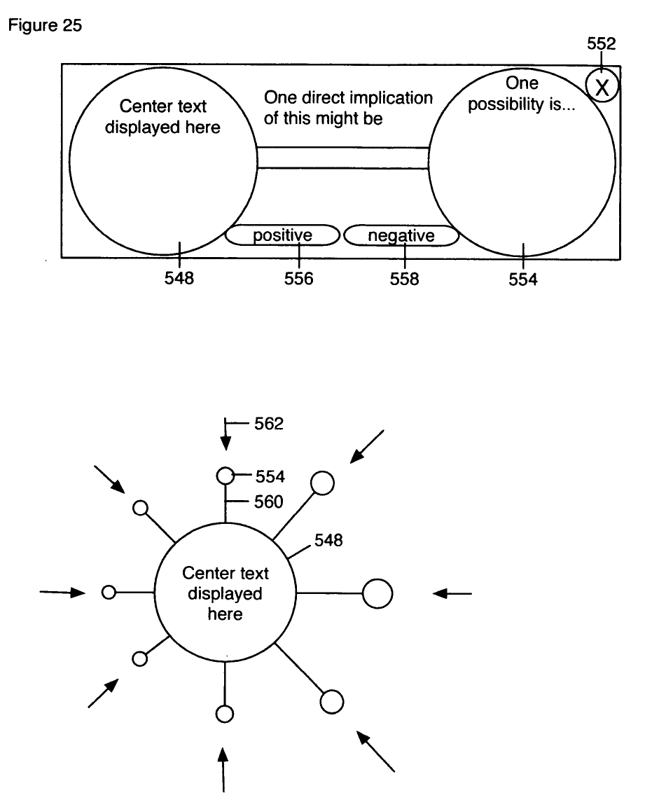

If the implication is being added to a hidden page, the page currently displayed is closed and the page showing the newly added first order implication is displayed, oval-arrow 188. The displayed page may appear as suggested in FIGS. 25 and 26. The arrows 562 of FIG. 25 indicated motion, e.g. the first order implications being drawn into the center node 548 to hide the page. FIG. 26 shows the page that is displayed with the newly added first order implication. At this point, the method reiterates the portion previously described starting at oval-arrow 186.

From oval-arrow 186, the prompt asking for additional first order implications is encountered, parallelogram 170. Such prompt is displayed in FIGS. 23-26, whereupon the cycle is repeated.

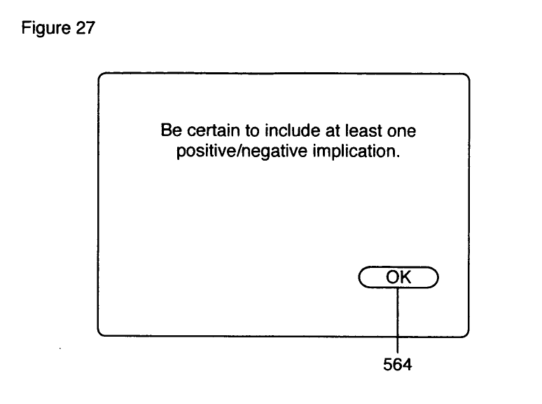

When four or more first order implication nodes 554 have been added to the center node 548, a new step is introduced as indicated at diamond 182. A decision is made as to whether there is at least one positive implication, diamond 190. Presuming a positive implication is present, the method verifies whether there is at least one negative implication, diamond 192. If only positive or only negative implications are present, the user is reminded to add at least one positive or negative implication, perhaps in the manner shown in FIG. 27, closeable perhaps by clicking button 564. Preferably such reminder is used, since people often have a bias toward seeing only positive or negative implications and often must be prodded to think outside their biases. Clicking the button 564 or having both positive and negative implications, causes initiation of the next step, previously described with regard to diamond 184. The method continues to loop until the user closes the prompt for additional first order implications at parallelogram 170, whereupon the user is directed to the interface, rectangle 172.

Interface

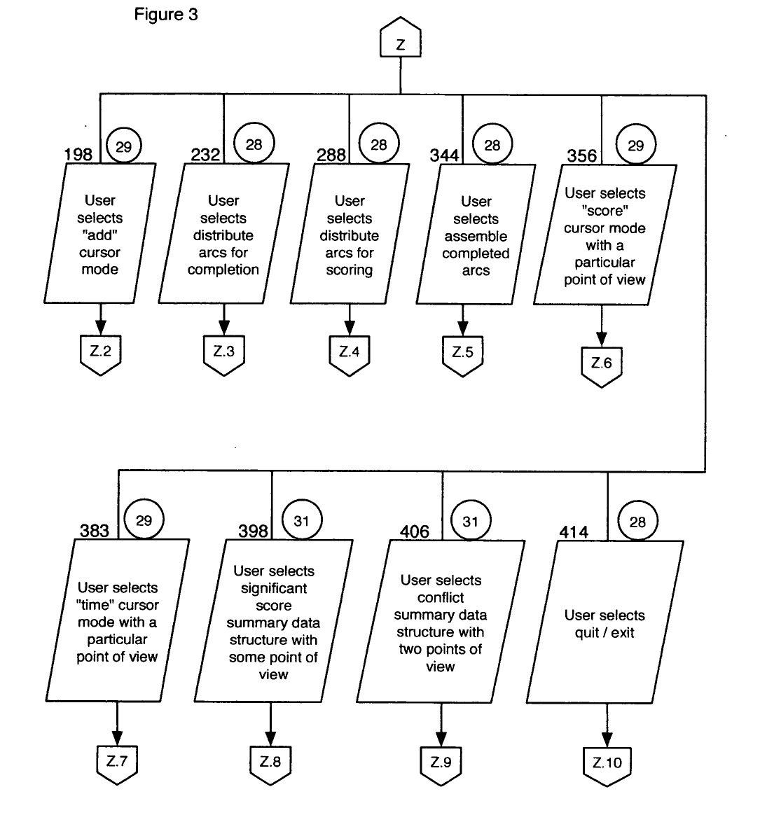

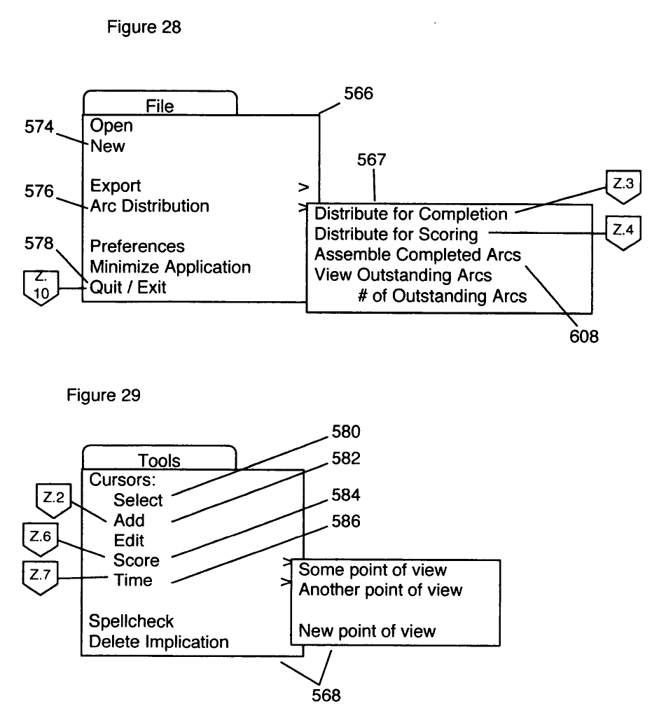

A flowchart for the interface is shown in FIG. 3. Perhaps four windows or pull-down screens 566, 568, 570, and 572, perhaps with sub-screens are available from the interface. Examples, of the pull-won screen are shown in FIGS. 28, 29, 30, and 31. Each of these pull-down screens allow access or provide data for other portions of the method. That is, the user may select from the interface which portion of the method they wish to execute. The user enters the interface from portions of the various flow charts that display an inverted pentagon circumscribing the letter “Z”, which directs the user into the interface flow chart on FIG. 3 at the upright pentagon circumscribing the letter “Z”. The user exits the interface through any of the inverted pentagons Z.2 through Z.10. Encircled below the inverted pentagons is a Figure number identifying the figure to which the user is referred as the next step of the method.

Pull-down screen 566, FIG. 28, allows the user the options of opening a “new” file, previously described, exporting an arc for distribution, or quitting 574, 576, and 578 respectively. Other options may be added if desired. Arcs may be distributed for completion or scoring.

The tools screen 568, shown in FIG. 29, provides the user with the options 580, 582, 584, and 586 respectively of setting the cursor to “select” (selecting an implication for close-up viewing), “add” (adding implications), “score” (scoring implications) or “time” (adding time parameters). Other options may also be present and where important to disclosing the best mode of making an using the invention are further described herein.

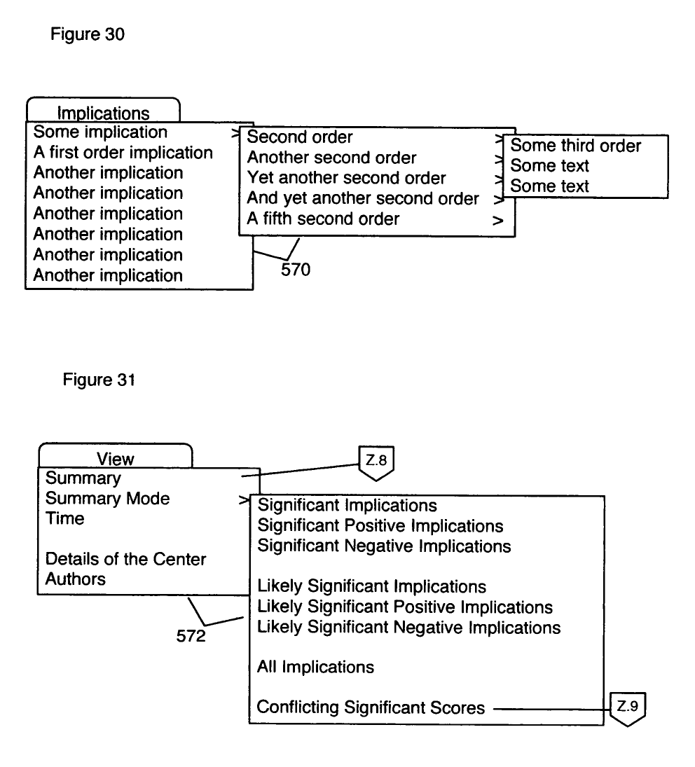

FIG. 30 allows the user to view the various implications in a variant format and is used for purposes described further below.

FIG. 31 allows the user to view relevant information in particular formats identified in the figure and describe herein.

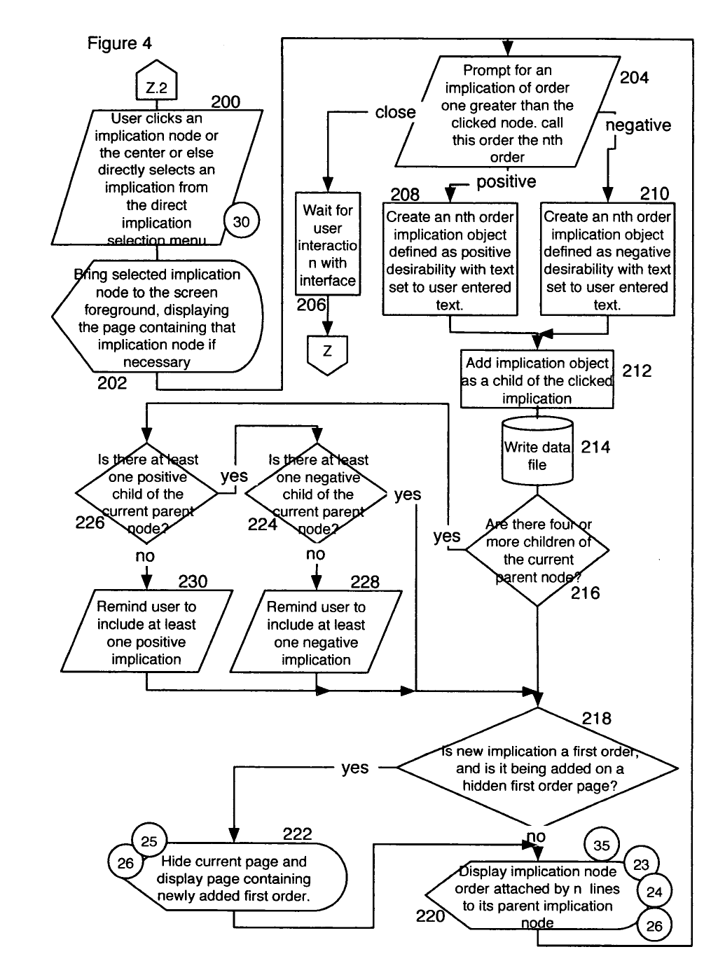

Selecting one of the options of FIGS. 28 or 29 bring the user to various points in the flow chart. For instance, selecting “quit/exit”, option 578 in FIG. 28, terminates the program as shown in FIG. 12. Selecting “add” in FIG. 28 allows the user to add additional implications of any order. That is, selecting “add”, option 582 in FIG. 29, makes the next step to be that indicated in FIG. 4 beneath the upright pentagon with the designation “Z.2” corresponding to the “Z.2” designation in the inverted pentagon on FIG. 29. Options 574 and 576 of FIG. 28 and options 580, 584, an 586 operate in a similar manner using inverted pentagons as directors in the various figures in a similar manner.

Adding Any Order Implication

Parallelogram 198 identifies the step where the user has selected “add” in the cursor mode, e.g. FIGS. 3 and 29 as previously described show the point in the interface where the user may select the “add” mode. At this point, rectangle 200 of FIG. 4, the user may click on or otherwise select a node, any order or the center node 548 or may directly select any implication from the implications menu, FIG. 30. Please note the wheel may be displayed while the menus shown in FIG. 28-31 are also being displayed and the user may click on any one of the displayed nodes. Upon selection of a node, the node may be brought to the foreground and the page containing the node may also be displayed, as indicated by oval arrow 202.

Next, a prompt may be displayed seeking an implication of an order one greater than the selected node (hereinafter “nth order node”), parallelogram 204. The user has three options, close, input an implication designating it either positive or negative similarly as described in regard to parallelogram 170 and FIGS. 22-26. (Note, that instead of building from the center node as described in parallelogram 170 and shown in the FIGS. 22-26, the user at this point may be building from any order of implication.) Should the user close the prompt, the method waits for user interaction at the afore-described interface, rectangle 206. Should the user write an implication and designate it as either positive or negative, the method creates an nth order implication defined as positive or negative desirability respectively with the text set to the user entered text, rectangles 208, 210. An implication is added as a child of the selected implication, rectangle 212, and data is written to the file, cylinder 214.

A decision, diamond 216, is made as to whether there are four or more children of the selected node, the outcome of which causes the method to initiate one of two loops. Assuming less than four nth order implications have been written, a decision is made, diamond 218, as to whether the nth implication is a first order implication and whether it is being added on a hidden first order page. While hidden pages may be used with second, third and subsequent order implications, the preferred mode of making and using the present invention does not provide for hidden second and subsequent order implications.

If the nth order implication is not a first order implication or it is not being written on a hidden page, the node 554 displaying the nth order node is displayed being joined to the parent node with n lines, e.g. a second order node is joined with two lines to the first order node. A first order implication is displayed as being joined by a single line 560 to the center node 548 as shown in FIGS. 23, 24, and 26 and indicated in oval-arrow 220 of FIG. 4. FIG. 23 shows display of the first of the first order implications joined to the center. FIG. 24 shows a number of first order nodes 554 joined to the center node 548. FIG. 26 demonstrates that multiple pages may be present, but as noted herein newly added first order implications may be added to the page currently being displayed.

If the nth order implication is a first order implication and is being added to a hidden page, the page currently displayed is closed and the page showing the newly added first order implication is displayed, oval-arrow 220. The displayed page may appear as suggested in FIGS. 25 and 26. The arrows 562 of FIG. 25 indicate motion, e.g. the first order implication nodes 554 being drawn into the center node 548 to hide the page. FIG. 26 shows the page that is displayed with the newly added first order implication node 554. At this point, the oval-arrow 220, previously described is encountered.

From oval-arrow 220, the prompt asking for additional nth order implications is encountered, parallelogram 204. Such prompt may be similar to that displayed in FIGS. 23-26 with or without the text of the parent implication, whereupon the cycle is repeated.

When four or more nth order implications have been added to the parent node, a new step is introduced as indicated at diamond 224. A decision is made as to whether there is at least one positive implication, diamond 226. Presuming a positive implication is present, the method verifies whether there is at least one negative implication, diamond 228. If only negative implications or only positive implications are present, the user is reminded to add at least one positive or negative implication, perhaps in the manner shown in FIG. 27, since any occurrence of an event can have both positive and negative implications, rectangles 228, 230 respectively. Clicking the button 564 or having both positive and negative implications, causes initiation of the next step, previously described with regard to diamond 218. The method continues to loop until the user closes the prompt for additional nth order implications at parallelogram 204, whereupon the user perhaps may only interact with the interface, rectangle 206.

Distribute Arcs for Completion

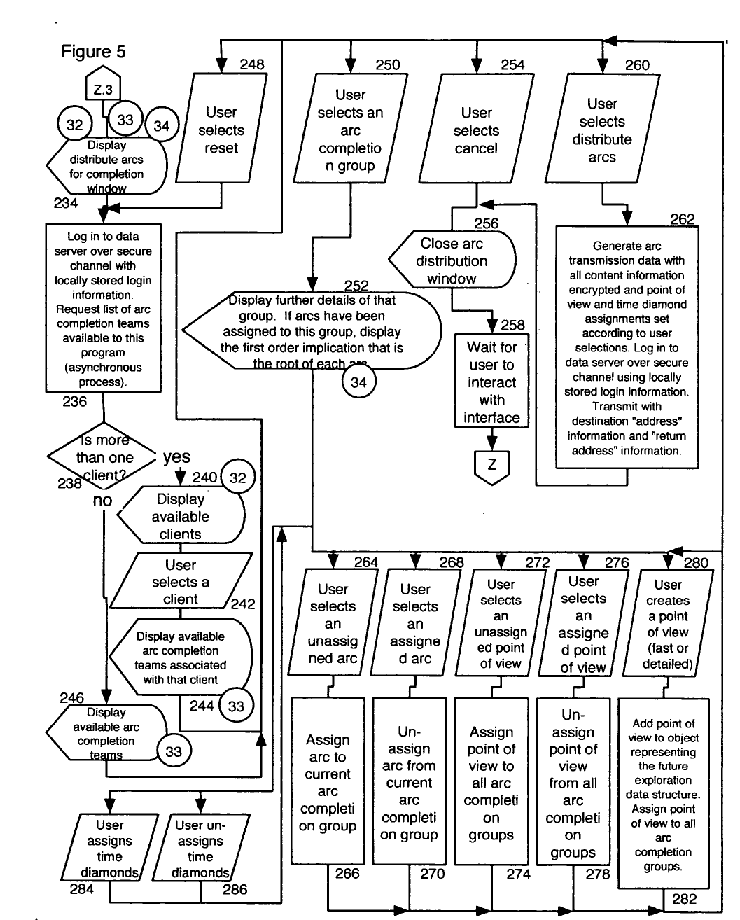

The user may select to distribute arcs for completion from the interface as indicated at parallelogram 232 of FIG. 5 and FIG. 28, option 576. The distribute arcs for completion window 567 may be displayed next to the file window 566 as shown in FIG. 28 and indicated at oval arrow 234 in FIG. 5. The method then performs a process step of logging in to the data server over a secure channel with locally stored login information, where a request is made for a list of arc completion teams available to this process; rectangle 236. This may be an asynchronous process.

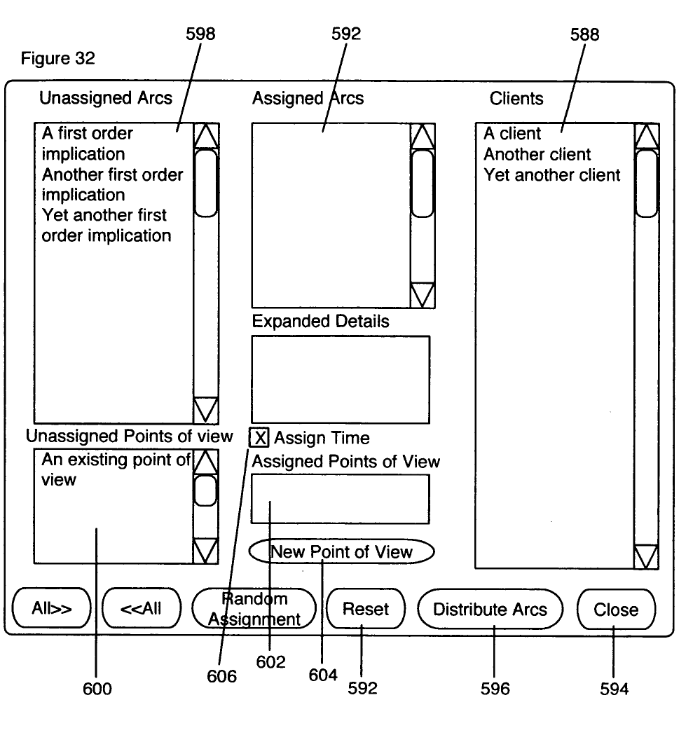

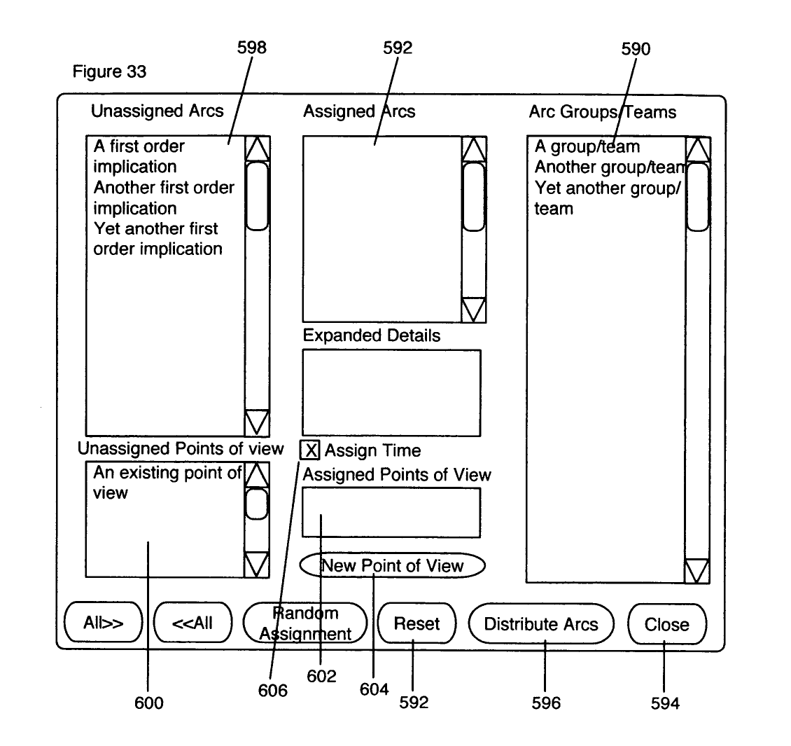

A decision is made as to whether there is more than one client; diamond 238. (This may occur where a consultant, e.g. the user, consults with multiple clients and does not want data from the different clients to be provided to the wrong entity.) An example of this display is shown in field 588 of FIG. 32. If so, available clients are displayed, oval-arrow 240, and the user selects a client, parallelogram 242. The available arc completion teams for that client are displayed perhaps in field 590 of FIG. 33, oval-arrow 244 (or oval-arrow 246 where there is only one client). An example of this display is shown in FIG. 33.

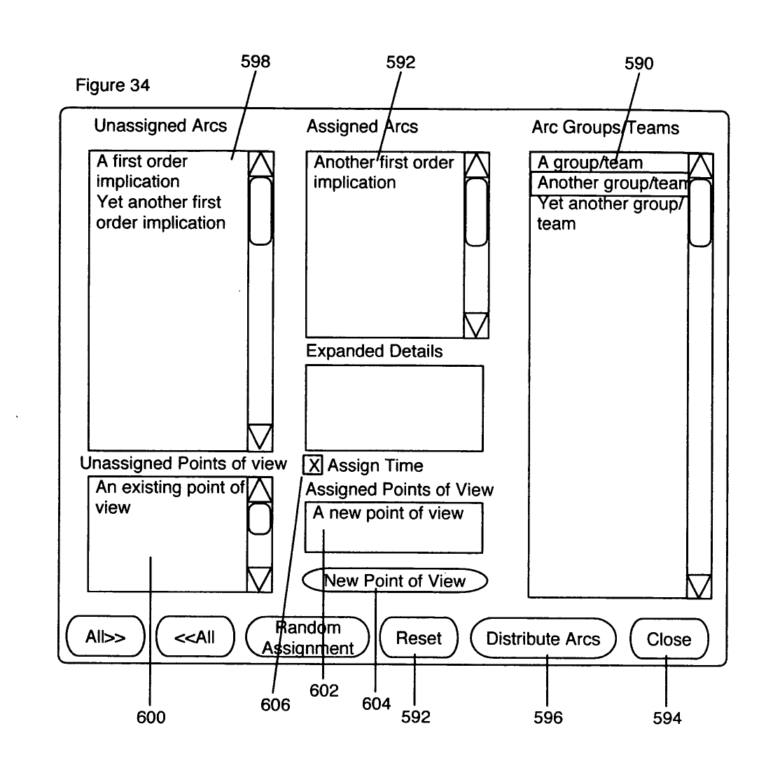

From either display, FIG. 32 or FIG. 33, the user has a multitude of choices, which lead to different results. These choices are set forth below.
The user may select “reset” perhaps by clicking on a button 592, which brings the method back to the step previously described in regard rectangle 236. (See parallelogram 248 of FIG. 5).
The user may select an arc completion group, field 590 of FIG. 33 and parallelogram 250 of FIG. 5, perhaps by clicking on one of the groups listed under the heading Arc Groups/Teams, which causes a display, oval-arrow 252, of further details of the group to be shown. The display may include a partial display of arcs assigned to the group in field 592, compare FIGS. 33 and 34, showing the first order implication that is the root of each arc.
The user may select “close” or “cancel”, parallelogram 254, perhaps by clicking button 594 in FIG. 32 or 33, which closes the arc distribution window and waits for user input at the interface, oval-arrow 256 and rectangle 258 of FIG. 5.
The user may select “distribute arcs” by clicking button 596; parallelogram 260, which leads to process step 262. The arc generation transmission data are generated with all content information encrypted and point of view and time diamond assignments set according to user selections. The method logs into the data server over a secure channel using locally stored login information. The arc transmission data may be electronically transmitted with destination address, i.e. arc program identification, and return address information, i.e. wheel program identification and wheel file identification. Upon completion of this process step, rectangle 262, the method closes the arc distribution window as previously described at oval arrow 256 and continues from that point as previously described.
The user may select an unassigned arc in field 598, parallelogram 264, which assigns the arc to the currently selected arc completion group, rectangle 266.
The user may select an assigned arc in field 592, parallelogram 268, which un-assigns the arc from the current completion group, rectangle 270.
The user may select an unassigned point of view in field 600, parallelogram 272, which assigns the point of view to all arc completion groups, rectangle 274.
The user may select an assigned point of view in field 602, parallelogram 276, which un-assigns the point of view from all arc completion groups, rectangle 278.
The user may create a point of view, fast or detailed, in field 604, parallelogram 280, which adds the point of view to the object representing the future exploration data structure and assigns the point of view to all arc completion groups, rectangle 282.
The user may also assign time diamonds, parallelogram 284, or un-assign time diamonds, parallelogram 286. This selection may be made via clicking on the check box 606 shown on FIGS. 32-34 adjacent the identifier “Assign Time.”
   The user may select the points of view (assigned/un-assigned), arcs (assigned/unassigned), arc groups/teams (assigned/un-assigned) by clicking on the words representing the particular choice. These options will continue to be presented until the close arc distribution step is reached, e.g. oval-arrow 256. Arcs may be electronically distributed for completion only, e.g. identification of implications, or for completion and scoring.
   Distribution of Arcs for Scoring

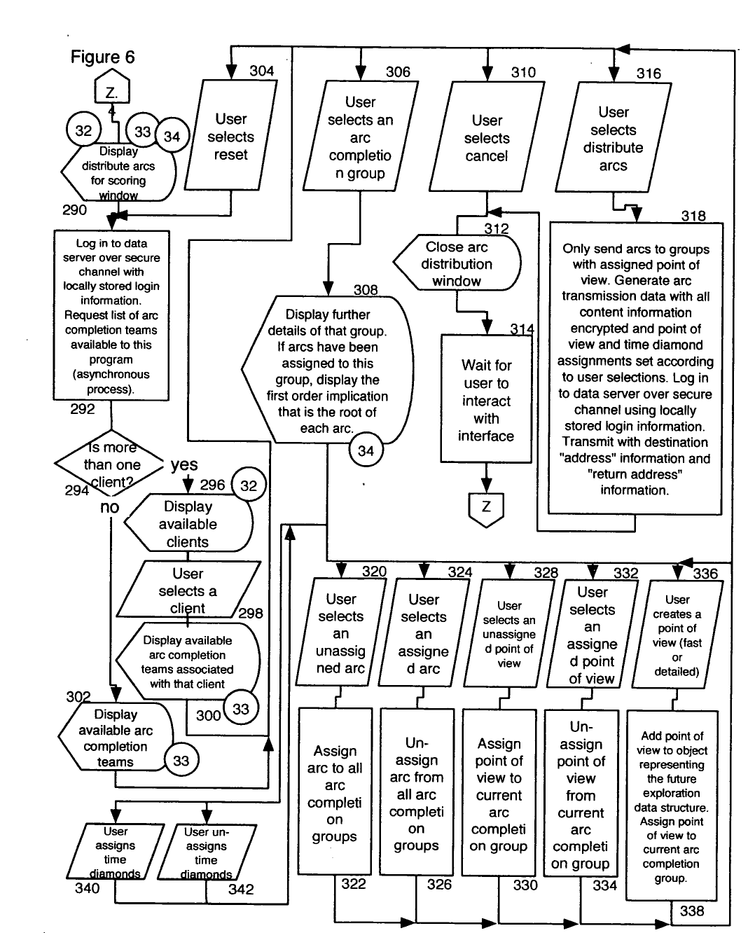

Distribution of arcs for scoring is substantially similar to distribution of arcs for completion with or without scoring. The flowchart boxes correspond in form and substance with the boxes on the distribute arcs for scoring, FIG. 6, being numbered 56 higher than the corresponding box in the distribute arcs for completion flow chart, FIG. 5. The steps with regard to such boxes from both flowcharts are considered the same unless specific mention of any difference is made. The differences between the flowcharts, FIG. 5 and 6 are as follows:

When the user selects to distribute the arcs, parallelogram 316, arcs are only sent to groups with an assigned point of view, rectangle 318. That is, to score, the user must know what point of view from which to score. Failure to assign a point of view to a particular group results in no arcs being sent to that group.

The process following the step of displaying further details of the selected group, e.g. oval-arrow 308 changes from the corresponding oval-arrow 252. When the user selects an unassigned arc, parallelogram 320, the arc is assigned to all arc completion groups, rectangle 322. When the user selects an assigned arc, parallelogram 324, the arc is unassigned from all arc completion groups. When the user selects an unassigned point of view, parallelogram 328, the point of view is assigned to the current arc completion group, rectangle 330. When the user selects an assigned point of view, parallelogram 332, that point of view is unassigned from the current arc completion group, rectangle 334. When the user creates a point of view, fast or detailed, parallelogram 336, the point of view is added to the object representing the future exploration data structure and the point of view is assigned to the current arc completion group, rectangle 338.

The other various steps in the flowchart for distributing arc for scoring may be substantially the same as the flowchart for distributing arc for completion with or without scoring. Those skilled in the art may find manners to modify the process without departing from the spirit and scope of the invention.

Assemble Arc Data Returned by Arc Program

An arc program may be used to complete the arcs and score the completed arcs. Such data may be accessed and incorporated into the present method in the following manner. The user may select to assemble completed and scored arcs at the interface, option 608 shown in FIG. 28 and indicated in FIG. 7 at parallelogram 344, perhaps by clicking on the displayed text or any other manner known in the art. The method logs in to a data server over a secure channel with locally stored login information and requests a list of returned arcs, rectangle 346. This may be an asynchronous step.

Next, rectangle 348, the method may login to a data server over a secure channel with locally stored login information. Each completed arc may be downloaded and confirmed when the download is complete, preferably asynchronous processes. As each arc is downloaded, the arcs may be incorporated into the data structure representing the future exploration tool. The data may then be written to the file, cylinder 350.

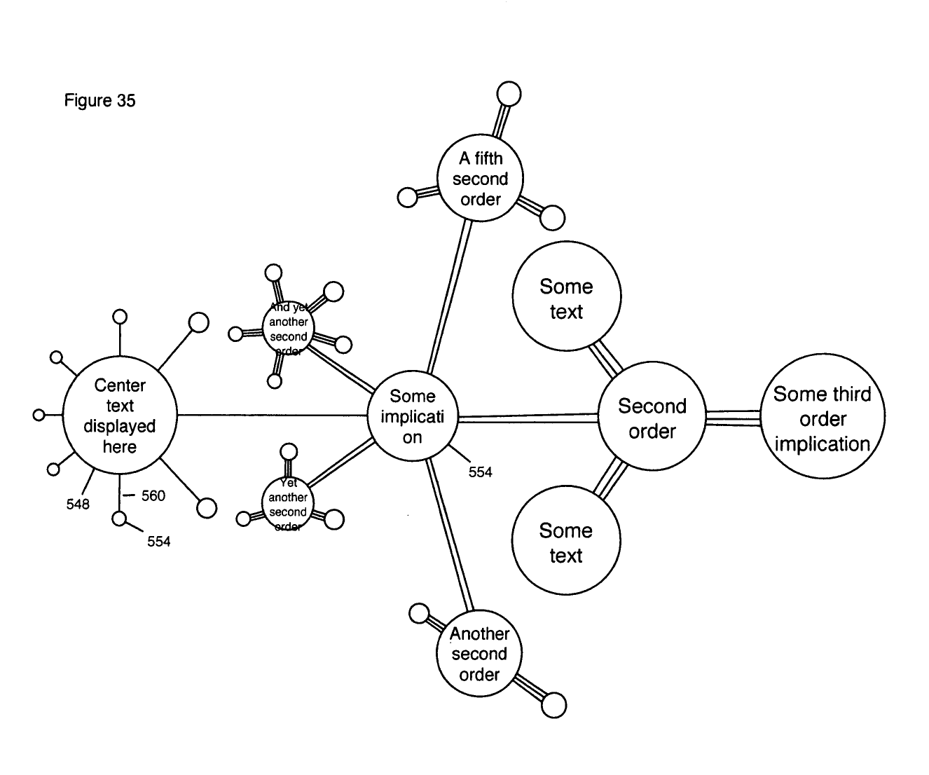

The newly assembled arc data may then be assembled, perhaps as shown in FIG. 35. Note, one skilled in the art understands that an interface may always be made accessible and although not shown in FIG. 35 an additional button may be include for accessing the interface. The method then waits for user interaction with the interface, FIGS. 28-31.

Scoring in Future Exploration Tool

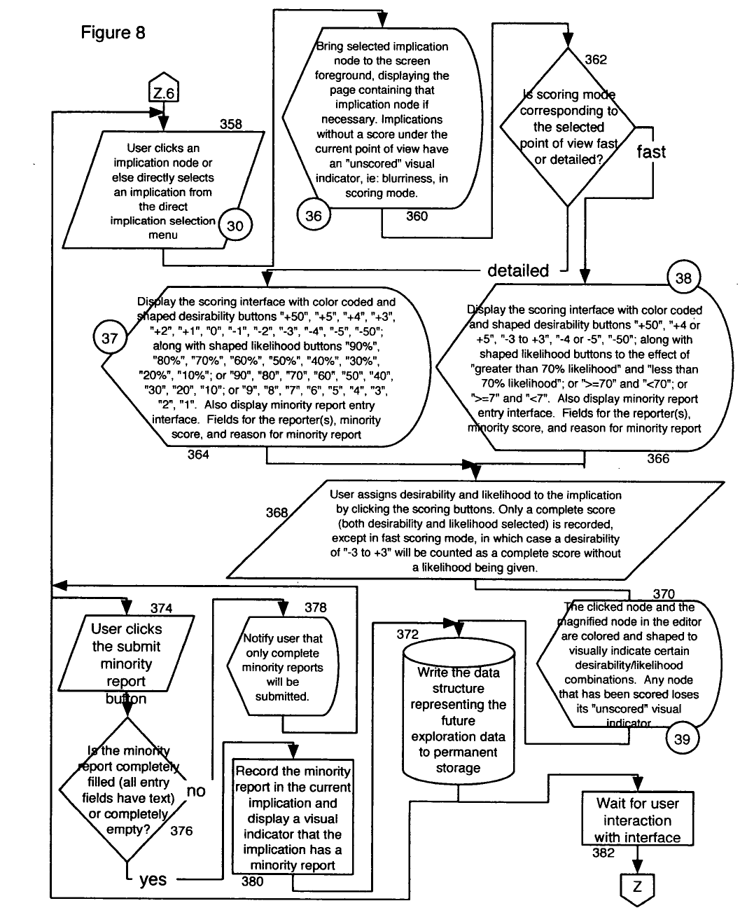

The user may select “score” cursor mode with a particular point of view, FIG. 28 and parallelogram 356 in FIG. 8. This allows the user to score the impact and likelihood of any particular implications. Next, parallelogram 358 of FIG. 8, the user directly selects an implication, e.g. via clicking on the desired node, or selects an implication from the direct implication selection menu (FIG. 31).

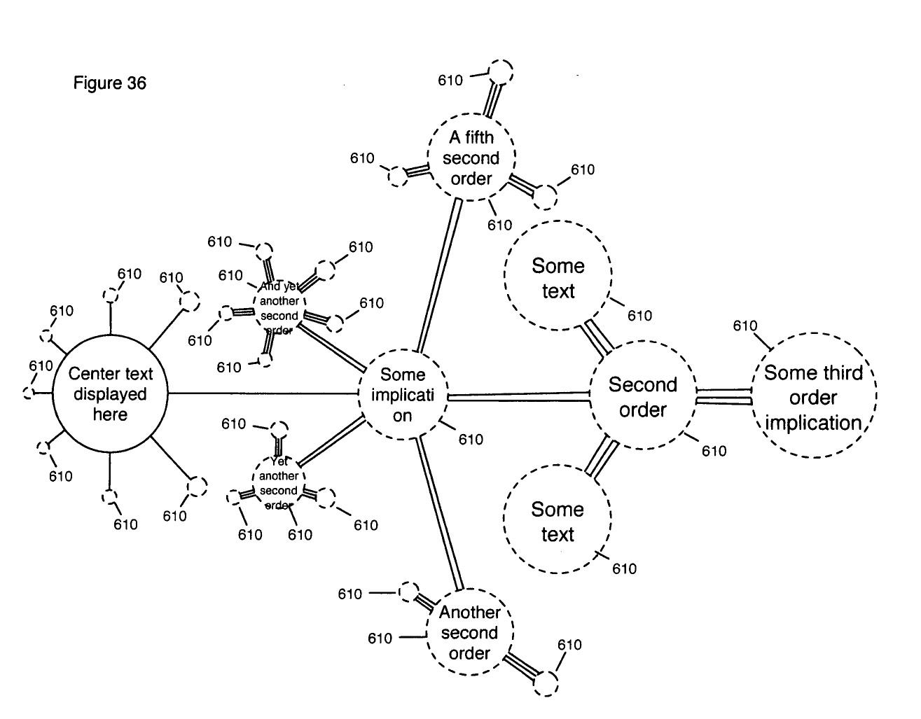

As indicated by oval-arrow 360, the selected implication node is brought to the screen foreground displaying the page containing that implication node if necessary. Implications without a score may have a visual indicator, perhaps blurry jagged node representations 610 defining the nodes as shown in FIG. 36.

Next, diamond 362, a decision is made by the method as to whether the scoring is “fast” mode or “detailed” mode. The fast mode gathers less precise information then the detailed mode. An appropriate scoring interface is displayed for the particular scoring mode as described below.

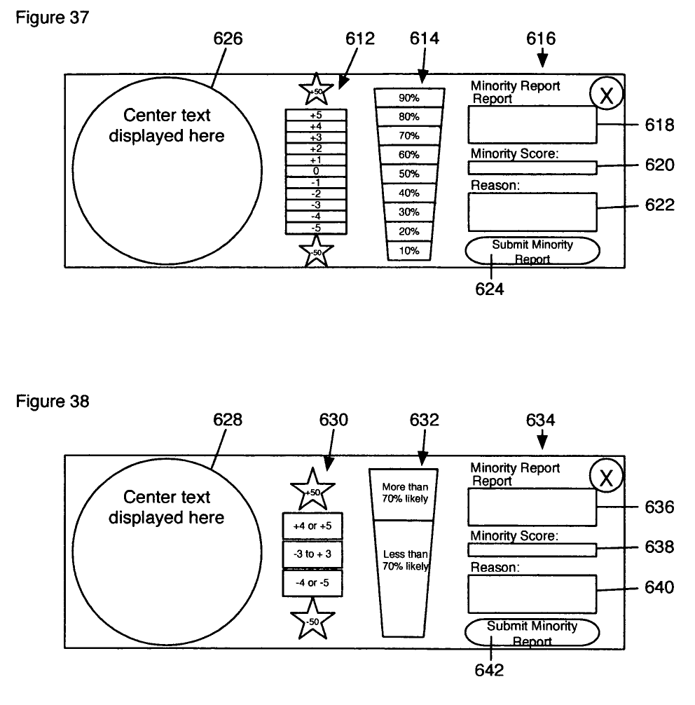

The “detailed” scoring interface, such as that shown in FIG. 37 and indicated in oval-arrow 364, shows the node being scored 626, buttons 612 for indicating desirability, buttons 614 for indicating likelihood, and a minority report interface 616. Preferably, the buttons 612 for desirability include a wide range of numerical indicators such as +50, +5, +4, +3, +2, +1, 0, −1, −2, −3, −4, −5, and −50. The higher numbered desirability is used to indicate the greater preference of the scoring for the occurrence of the implication. Such desirability buttons 612 may be color coded, perhaps in a gradient manner, perhaps with blue positive numbers with white or pale tones representing more neutral numbers and red representing the negative numbers. Preferably, the likelihood buttons 614 include a wide range of numerical indicators such as 90%, 80%, 70%, 60%, 50%, 40%, 30%, 20%, and 10% or 9, 8, 7, 6, 5, 4, 3, 2, and 1. For instance somebody may identify world peace as an implication of a summit meeting. Desirability may be marked as +50 according to a scoring method, but likelihood may be scored as 10% or 1.

On occasion, a group may form one conclusion where one person or less than a majority have a different conclusion. For this eventuality, a minority report interface 616 may also be displayed as indicated at oval-arrow 364 having fields for reporter 618, scoring 620, and reason 622. Often these minority reports are as important or more important than the majority opinion. Perhaps the minority has an insight or perspective that they are having difficulty in verbalizing. The minority report may be submitted by clicking on a button 624.

The “fast” scoring interface, such as that shown in FIG. 38 is displayed, oval-arrow 366, showing the node being scored 628, buttons 630 for indicating desirability, buttons 632 for indicating likelihood, and a minority report interface 634. Preferably, the buttons 630 for desirability include a narrower range of numerical indicators such as +50, +5 or +4, +3 to −3, −4 or −5, and −50. The higher numbered desirability is used to indicate the greater preference of the scoring for the occurrence of the implication. Such desirability buttons 630 may be color coded, perhaps in a gradient manner, perhaps with blue positive numbers with white or pale tones representing more neutral numbers and red representing the negative numbers. Preferably, the likelihood buttons 632 include a narrower range of numerical indicators perhaps being “greater than 70%” and “less than or equal to 70%”. A minority report interface 634 may also be displayed as indicated at oval-arrow 366 having fields for reporter 636, scoring 638, and reason 640. The minority report may be submitted by clicking on a button 624.

From the steps described in regard to oval-arrows 364 and 366, the method seeks input from the user, parallelogram 368. The user assigns desirability and likelihood to the implications by clicking on the scoring buttons 612 and 614 or 630 and 632. A response including both desirability and likelihood is required before the process can continue, except perhaps in fast scoring mode where a desirability of +3 to −3, e.g. neutral, does not require a likelihood scoring.

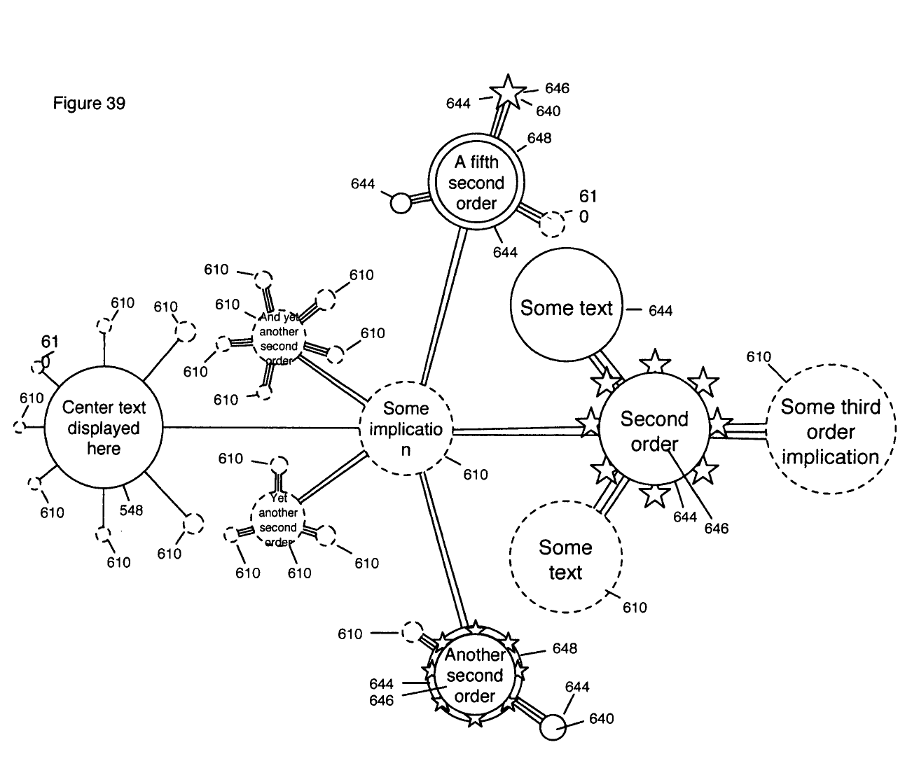

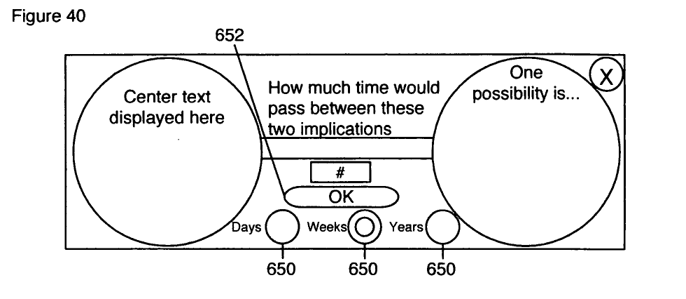

Next, oval-arrow 370, the scored nodes are colored and shaped to visually indicate the desirability and likelihood combinations. FIGS. 39 and 40 are examples of different visual indicators that may be used to depart information about scored and un-scored nodes. For example, nodes that have not been scored remain blurry or with jagged edges 610. Nodes that are not a child of the selected node may be presented in a small or abbreviated manner, such as shown by abbreviated nodes 642. Scored nodes are shown with a smooth non-jagged outer perimeter such as nodes 644. Significant nodes may be identified with stars such as nodes 646. Nodes with a high likelihood, e.g. greater than 70% may be visually identified with a second ring 648 about the node. That is, those with a significant desirability score and significant likelihood may be made more prominent so as to draw the viewer's attention to those nodes of the greatest impact and those of less impacting and less likely implications are displayed less prominently. Any scored node that was previously visually marked as such loses its visual “un-scored” indicator when it is scored.

Shape and color of implication nodes may be altered according to score using any technical means known in the art. In the preferred embodiment of the method, one pre-rendered image is stored with the program for each of the unique color and shape combinations that represent different desirability and likelihood combinations, that is: very desirable and not very desirable, very desirable and very likely, extremely desirable, extremely desirable and very likely, not scored in scoring mode, not significant desirability, very undesirable, very undesirable and very likely, extremely undesirable, extremely undesirable and very likely. Additional, pre-rendered graphics may be used for diminished nodes, the center, text entry nodes, and anywhere else an implication node is represented. The nodes used for conflict scoring may be generated from combinations of these pre-rendered images, or they may be pre-rendered images as well. A mapping is devised to convert scores in the method to unique identifiers that are used to load the correct, pre-rendered image. When an implication is to be displayed, the pre-rendered image is loaded and displayed on the computer screen to represent the node. The implication text may be colored using any means known in the art and placed in front of the node, so that when viewed on the screen, the viewer sees the implication text covering part of the implication node.

Desirability, e.g. very desirability or very undesirable, implications are preferably indicated by filling the implication node with color, the color being different for desirable and undesirable. That is, at least a portion of the indicator signifying desirability is positioned inside the node and likelihood is positioned outside the node or vice versa. Legibility of the implication text may be preserved by changing the color of the implication text so that it stands out against the implication node containing the text. To show high likelihood of very desirable or undesirable implications, the preferred embodiment of the invention will circle those implications that are both very desirable or undesirable. This visual key allows significantly desirable implications to stand out in a manner distinct from those that are of high likelihood, a significant improvement over what is found in the prior art.

The data are incorporated to that data structure representing the future exploration tool and written to permanent storage, cylinder 372. The method waits for either of three inputs, the user may submit a minority report, parallelogram 374, the user may score another node, as was described starting at parallelogram 358, or the user may go to the interface, rectangle 382 and FIGS. 28-31. When the user clicks the submit minority report button, parallelogram 374, a decision is made as to whether all fields contain data, diamond 376. If not, the user is notified that only complete minority reports will be submitted and the method is redirected to the point previously described with reference to parallelogram 374. If so, the minority report is recorded in the current implication and a visual indicator for a minority report, such as a subscript or superscript “M”, may be displayed next to the node that has a minority report, rectangle 380.

Timing

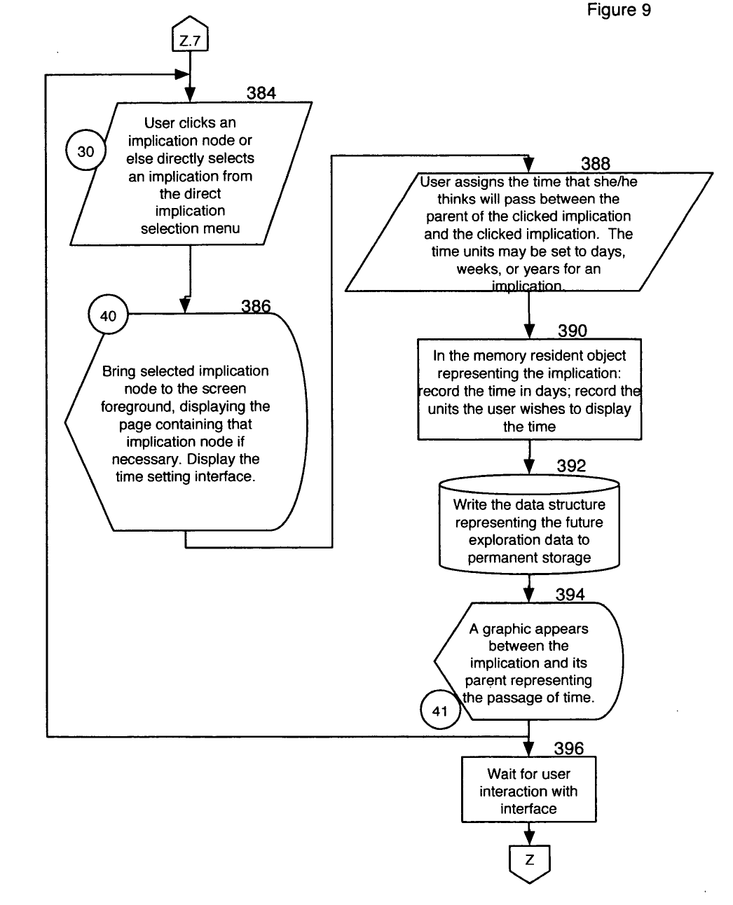

From the interface, FIG. 29, the user may select “time” cursor mode, option 584 with a particular point of view, parallelogram 382 of FIG. 9. The user may click an implication node or directly seek an implication from the implication selection menu, parallelogram 384 and FIG. 30. The selected implication node is brought to the screen foreground, displaying the page containing the implication node if necessary, oval-arrow 386. The time interface is displayed as shown in FIG. 40.

The user may assign the time that s/he or the group thinks will pass between the parent of the clicked implication and the clicked implication. The time units may be set to days, weeks, or years for an implication with buttons 650 and accepting the input by clicking button 652, parallelogram 388. In the memory resident object representing the implication the time may be recorded in days and the units of time measure the user wishes for display of the time, rectangle 390. The data structure representing the future exploration data is written to the permanent data storage, cylinder 392. A graphic is displayed between the clicked implication and its parent, perhaps a diamond-shape 654, representing and perhaps displaying the anticipated time, oval-arrow 394 and FIG. 41.

The user may continue the process previously described starting at parallelogram 384 through oval-arrow 394 as many times as desired or move to another activity selected from the interface FIGS. 28-31. See rectangle 396.

Summary Wheel

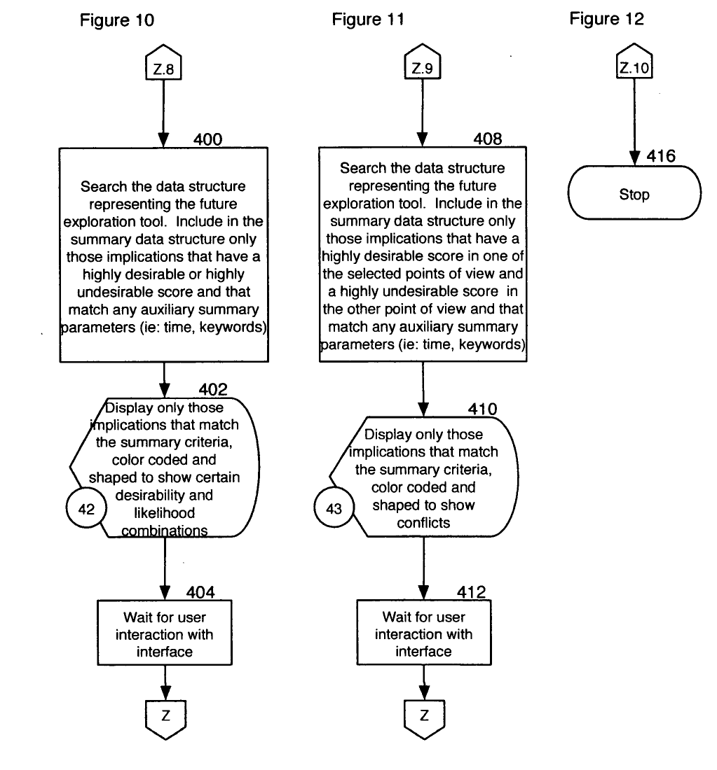

The user may select from the interface, FIG. 31 and parallelogram 398 on FIG. 10, significant score summary data structure with some point of view. Procedurally, rectangle 400, the method searches data structure representing the future exploration tool and includes in the summary data structure only those implications that have a high desirability/high undesirability score and that match any auxiliary summary parameters, e.g. time, keyword or other together with any ancestor nodes necessary to connect the identified implications to the center.

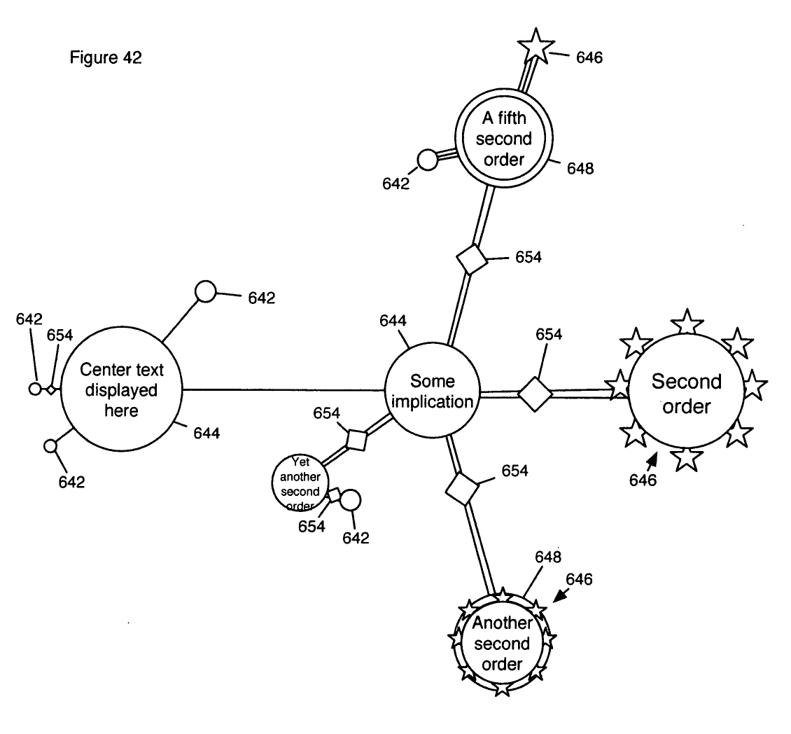

As indicated by oval-arrow 402 and shown in FIG. 40 only those implications that match the summary criteria are displayed with those ancestors necessary to connect to the center. FIG. 42 is a summary of FIG. 41. This may be done with indicia such as color codes an shapes to convey certain desirability and likelihood combinations. The method waits for user interaction at the interface, FIGS. 28-31, rectangle 404.

Conflict Summary Wheel

The user may select from the interface, FIG. 31 and parallelogram 406 on FIG. 11, significant score summary data structure with two or more points of view, preferably two. Procedurally, rectangle 408, the method searches data structure representing the future exploration tool and includes only in the summary data structure only those implications that have a high desirability score in one of the selected points of view and high undesirability score in another selected point of view and that match any auxiliary summary parameters, e.g. time, keyword or other together with any ancestor nodes necessary to connect the identified implications to the center. That is, those implications that were scored in conflict under different points of view are include in the summary data structure.

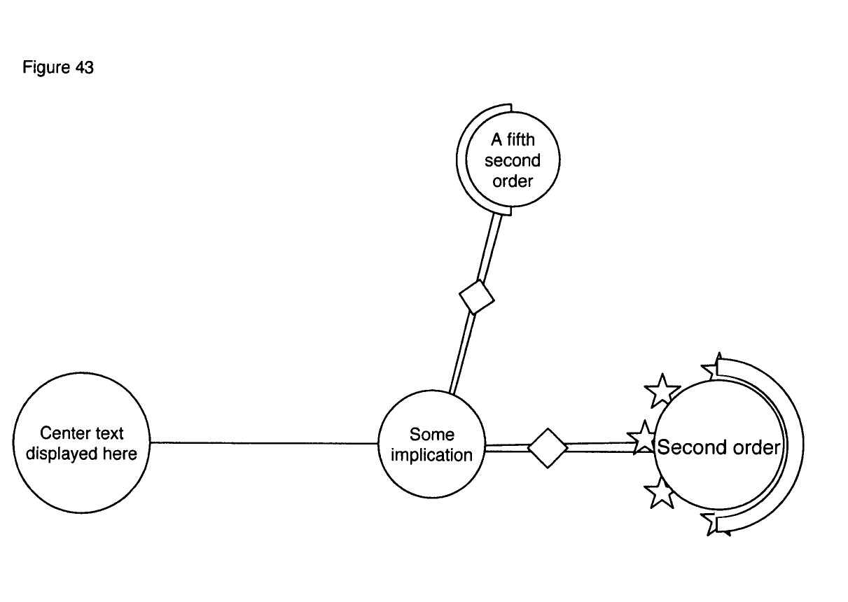

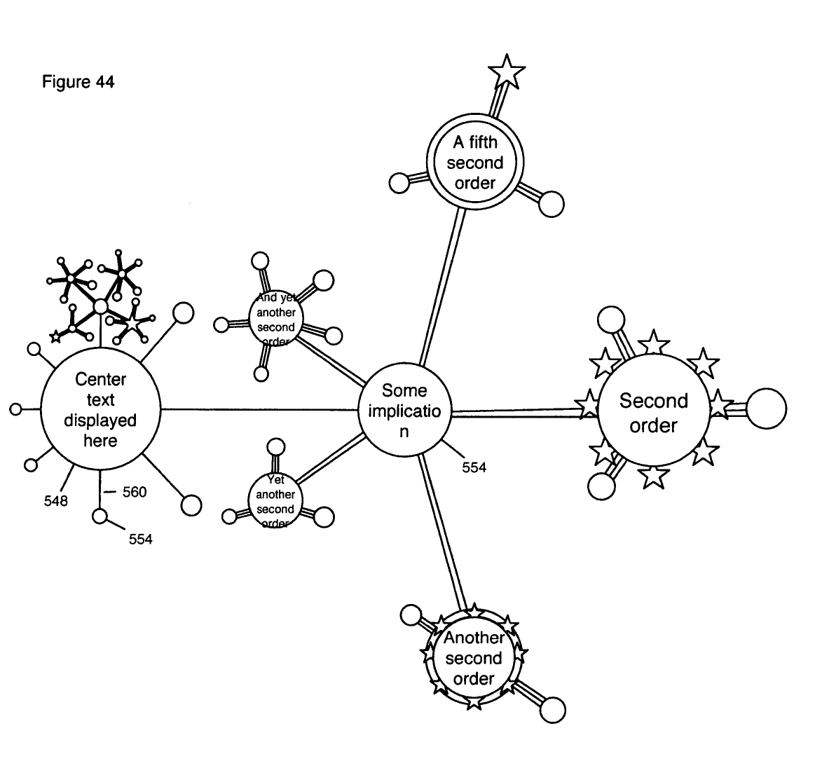

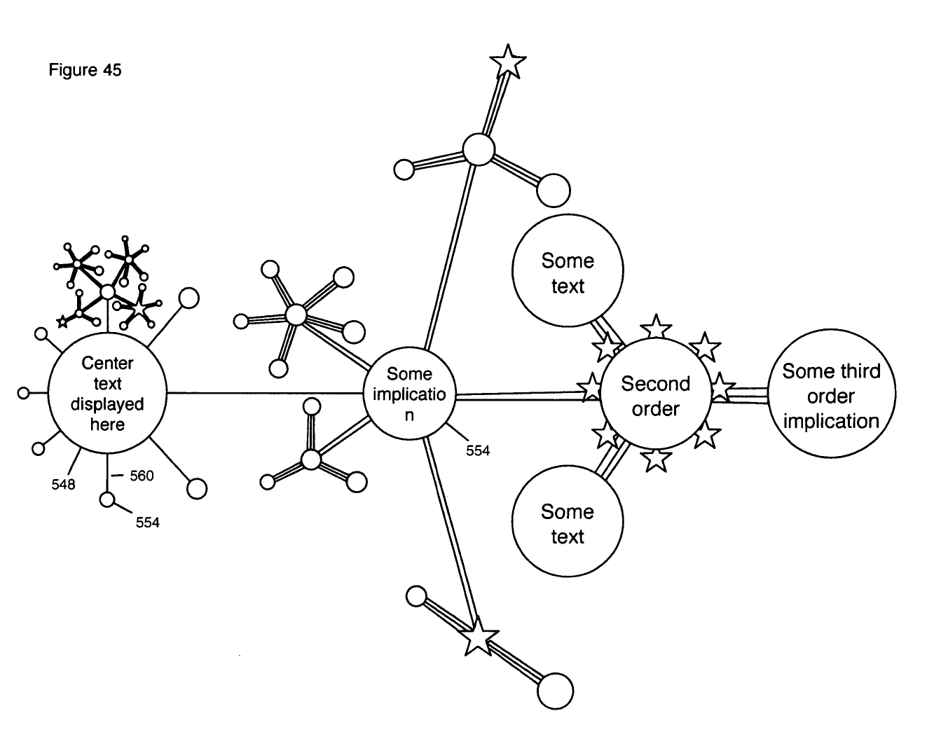

As indicated by oval-arrow 410 and shown in FIG. 43, only those implications that match the summary criteria are displayed with those ancestors necessary to connect to the center. This may be done with indicia such as color codes an shapes to convey certain desirability an likelihood combinations, generally using the indicia for one score on one side of the node and the indicia for the score in the alternative point of view is placed opposite that of the first point of view as shown by nodes 656. The method waits for user interaction at the interface, FIGS. 28-31, rectangle 404.

Exiting the Program

From the user interface, FIG. 28 and parallelogram 414 on FIG. 12, the user may select to quit or exit the program, option 578. At this point the program stops as indicated by oval 416.

Although the present invention has been described with reference to preferred embodiments, workers skilled in the art will recognize changes may be made in form and detail without departing from the spirit and scope of the invention. For instance, different indica and shapes may be used to impart information concerning the nodes and scoring thereof.

1) A method of exploring; comprising the steps of:
writing center text;
displaying the center text in a center node;
writing first order implications, each first order implication forming at least a part of an arc;
displaying each first order implication in a first order node;
connecting each first order node to the center node;
writing any desired child implications of any existing implications;
displaying the child implications in child nodes;
connecting the child nodes to an associated parent node to form a wheel; and
preparing and displaying a summary of the wheel including only those implications, together with any ancestor implications necessary to connect to the center text, that are both significant implications and match any user determined auxiliary summary parameters.

2) The method of claim 1 further comprising the step of:
visually rotating the wheel in a plane skewed to a plane defined by a monitor screen.

3) The method of claim 2 wherein the wheel is rotated when any node is selected;
the selected node is rotated to the foreground.

4) The method of claim 1 wherein the nodes forming the wheel are displayed in a diminished mode such that the implication within the node is not revealed.

5) The method of claim 4 further comprising the step of:
fully displaying each node including revealing each implication within each node.

6) The method of claim 4 further comprising the step of:
fully displaying a portion of the nodes, including revealing the implications within some of the nodes.

7) The method of claim 1 further comprising the steps of:
encrypting data associated with one arc; and
electronically distributing that arc for completion and scoring.

8) A method of exploring; comprising the steps of:
writing center text;
displaying the center text in a center node;
writing first order implications, each first order implication forming at least a part of an arc;
displaying each first order implication in a first order node;
connecting each first order node to the center node;
writing any desired child implications of any existing implications;
displaying the child implications in child nodes;
connecting the child nodes to an associated parent node to form a wheel
scoring the implications according to at least two view points; and
preparing and displaying a conflict summary wheel including only those implications, together with any ancestor implications necessary to connect to the center text, that both are significant implications and received a conflicting score between at least two different viewpoints.

9) The method of claim 8 further comprising the step of:
visually rotating the conflict summary wheel in a plane skewed to a plane defined by a monitor screen.

10) The method of claim 9 wherein the wheel is rotated when a node is selected; the selected node being rotated to the foreground.

11) The method of claim 8 wherein the nodes forming the wheel are displayed in a diminished mode such that the implication within the node is not revealed.

12) The method of claim 11 further comprising the step of:
fully displaying each node including revealing each implication within each node.

13) The method of claim 11 further comprising the step of:
fully displaying a portion of the nodes, including revealing the implications within some of the nodes.

14) The method of claim 8 further comprising the steps of:
encrypting data associated with one arc; and
electronically distributing that arc for completion and scoring.

15) A method of exploring; comprising the steps of:
writing center text;
displaying the center text in a center node;
writing first order implications, each first order implication forming at least a part of an arc;
displaying each first order implication in a first order node;
connecting each first order node to the center node;
writing any desired child implications of any existing implications;
displaying the child implications in child nodes;
connecting the child nodes to an associated parent node to form a wheel; and
randomly selecting any node of any order to be scored by clicking on the node;
scoring the selected node as to significance and likelihood; and
visually removing indicia designating a node as non-scored and marking the node as scored once the node is scored, such marking being positionable inside the node, on the line defining the node and outside the node.

16) The method of claim 15 the step of marking the node as scored further comprising the steps of:
coloring the inside of the node; and
changing the color of text within the node.

17) The method of claim 15 further comprising the step of:
distributing arcs for completion and scoring; and
combining completed and scored arcs into a wheel.

18) The method of claim 17 further comprising the step of:
visually rotating the wheel in a plane skewed to a plane defined by a monitor screen.

19) The method of claim 18 wherein the wheel is rotated when a node is selected;
the selected node being rotated to the foreground.

20) The method of claim 17 wherein the nodes forming the wheel are displayed in a diminished mode such that the implication within the node is not revealed.

21) The method of claim 20 further comprising the step of:
fully displaying a portion of the nodes, including revealing the implications within some of the nodes.
